(19) United States
(12) Patent Application Publication
(10) Pub. No.: US 2025/0038580 A1
(43) Pub. Date: Jan. 30, 2025

(54) WIRELESS POWER TRANSMISSION SYSTEM AND A METHOD OF OPERATING THE SAME

(71) Applicant: SAMSUNG ELECTRONICS CO., LTD., SUWON-SI (KR)

(72) Inventors: Byungwook JUNG, Suwon-si (KR); Dohyung KIM, Suwon-si (KR); Jaesup LEE, Suwon-si (KR); Solhee IN, Suwon-si (KR)

(21) Appl. No.: 18/610,709

(22) Filed: Mar. 20, 2024

(30) Foreign Application Priority Data
Jul. 27, 2023 (KR) 10-2023-0098150

(51) Int. Cl. H02J 50/80; H02J 50/20; H02J 50/40

(52) U.S. Cl. CPC H02J 50/80; H02J 50/20; H02J 50/40

(57) ABSTRACT

A wireless power transmission system including: a first wireless power transmitter to receive a beacon signal through a first array antenna unit, estimate a characteristic of a first wireless channel based on the beacon signal, and generate and output first power signals, wherein phases and amplitudes of the first power signals are adjusted based on a characteristic of the first wireless channel and a time reversal algorithm; and a first wireless power receiver to output the beacon signal through a first antenna unit, receive the first power signals through the first antenna unit, and generate an operating voltage based on the first power signals, wherein the first power signals are adjusted differently based on a quantity of wireless power transmitters, a quantity of wireless power receivers, a movement of the first wireless power transmitter, or a movement of the first wireless power receiver.

### CROSS-REFERENCE TO RELATED APPLICATION

This application claims priority under 35 U.S.C. § 119 to Korean Patent Application No. 10-2023-0098150 filed on Jul. 27, 2023 in the Korean Intellectual Property Office (KIPO), the disclosure of which is incorporated by reference herein in its entirety.

### 1. TECHNICAL FIELD

Example embodiments of the present disclosure relate generally to semiconductor integrated circuits, and more particularly to wireless power transmission systems, and methods of operating the wireless power transmission systems.

### 2. DESCRIPTION OF THE RELATED ART

Wireless power transmission technology, which delivers electrical energy wirelessly to a receiver, has been developed through various methods. These methods include transferring electrical energy using electromagnetic waves, such as radio waves or lasers, from a transformer or an electric motor through electromagnetic induction. To date, wireless energy transfer has utilized several approaches: magnetic induction technology, magnetic resonance technology, and long-distance transmission technology using microwave frequencies at short wavelengths.

In wireless power transmission technology that employs microwave frequencies with short wavelengths, beamforming transmission is mainly used. This method involves a transceiver receiving electronic signals in three dimensions from a receiver to specify the location of the receiver. However, if the location of the receiver is changed or there is an obstacle in a direct line between the receiver and the transceiver, power transmission efficiency may be reduced. Consequently, ongoing research is focused on mitigating these reductions in power transmission efficiency.

### SUMMARY

At least one example embodiment of the present disclosure provides a wireless power transmission system and a method of operating the wireless power transmission system that can improve or enhance power transmission efficiency in various operating environments and scenarios.

According to an example embodiment of the present disclosure, there is provided a wireless power transmission system including: a first wireless power transmitter including a first array antenna unit including a plurality of antennas, the first wireless power transmitter configured to receive a first beacon signal through the first array antenna unit, to estimate a characteristic of a first wireless channel based on the first beacon signal, to generate a plurality of first power signals, and to output the plurality of first power signals through the first array antenna unit, wherein phases and amplitudes of the plurality of first power signals are adjusted based on the characteristic of the first wireless channel and a time reversal algorithm; and a first wireless power receiver including a first antenna unit including at least one antenna, the first wireless power receiver configured to output the first beacon signal through the first antenna unit, to receive the plurality of first power signals through the first antenna unit, and to generate a first operating voltage based on the plurality of first power signals, wherein the first wireless channel is between the first wireless power transmitter and the first wireless power receiver, and wherein the plurality of first power signals are adjusted differently based on a quantity of wireless power transmitters including the first wireless power transmitter, a quantity of wireless power receivers including the first wireless power receiver, a movement of the first wireless power transmitter, or a movement of the first wireless power receiver.

According to an example embodiment of the present disclosure, there is provided a method of operating a wireless power transmission system including a first wireless power transmitter and a first wireless power receiver, the method including: transmitting, by the first wireless power receiver including a first antenna unit, a first beacon signal to the first wireless power transmitter through the first antenna unit, the first antenna unit including at least one antenna; estimating, by the first wireless power transmitter including a first array antenna unit, a characteristic of a first wireless channel based on the first beacon signal received through the first array antenna unit, the first array antenna unit including a plurality of antennas, the first wireless channel being between the first wireless power transmitter and the first wireless power receiver; generating, by the first wireless power transmitter, a plurality of first power signals whose phases and amplitudes are adjusted based on the characteristic of the first wireless channel and a time reversal algorithm; transmitting, by the first wireless power transmitter, the plurality of first power signals to the first wireless power receiver through the first array antenna unit; and generating, by the first wireless power receiver, a first operating voltage based on the plurality of first power signals received through the first antenna unit, and wherein the plurality of first power signals are adjusted differently based on a quantity of wireless power transmitters including the first wireless power transmitter, a quantity of wireless power receivers including the first wireless power receiver, a motion of the first wireless power transmitter, or a motion of the first wireless power receiver.

According to an example embodiment of the present disclosure, there is provided a wireless power transmission system including: a first wireless power transmitter to a M-th wireless power transmitter configured to generate a plurality of first power signals to a plurality of M-th power signals, where M is a natural number greater than or equal to two; and a first wireless power receiver to a N-th wireless power receiver configured to generate a first beacon signal to a N-th beacon signal, and to operate based on the plurality of first power signals to the M-th power signals, where N is a natural number greater than or equal to two, wherein a X-th wireless power transmitter among the first to M-th wireless power transmitters includes a X-th array antenna unit including a plurality of antennas arranged in a two-dimensional matrix, where X is a natural number greater than or equal to one and less than or equal to M, wherein a Y-th wireless power receiver among the first to N-th wireless power receivers includes a Y-th antenna unit including at least one antenna, where Y is a natural number greater than or equal to one and less than or equal to N, wherein the X-th wireless power transmitter is configured to receive the first to N-th beacon signals through the X-th array antenna unit, to estimate characteristics of a first wireless channel to a N-th wireless channel based on the first to N-th beacon signals, to generate a plurality of X-th power signals whose phases and amplitudes are adjusted based on the characteristics of the first to N-th wireless channels and a time reversal algorithm, and to output the plurality of X-th power signals through the X-th array antenna unit, wherein the first to N-th wireless channels are between the X-th wireless power transmitter and the first to N-th wireless power receivers, wherein the Y-th wireless power receiver is configured to output the Y-th beacon signal through the Y-th antenna unit, to receive the plurality of first to M-th power signals through the Y-th antenna unit, and to generate a Y-th operating voltage based on the plurality of first to M-th power signals, wherein, when a power transmission efficiency between the X-th wireless power transmitter and the Y-th wireless power receiver is lower than a reference power transmission efficiency, the phases and the amplitudes of the plurality of X-th power signals are adjusted, or at least one of the X-th array antenna unit and the Y-th antenna unit is moved, or at least one of the X-th wireless power transmitter and the Y-th wireless power receiver generates an alarm signal, wherein each of the first to M-th wireless power transmitters and the first to N-th wireless power receivers is a stationary device with a fixed position, or a mobile device whose position is changeable, and wherein the plurality of first to M-th power signals are adjusted differently based on at least one of a quantity of the first to M-th wireless power transmitters, a quantity of the first to N-th wireless power receivers, a movement of each of the first to M-th wireless power transmitters, and a movement of each of the first to N-th wireless power receivers.

In the wireless power transmission system and the method of operating the wireless power transmission system according to example embodiments of the present disclosure, both the phases and the amplitudes of the power signals may be adjusted based on the phase and amplitude control algorithm and the time reversal algorithm. Therefore, power transmission efficiency may be improved. In addition, the wireless power transmission system may be implemented in various operating environments and scenarios based on the quantity and the movability of wireless power transmitters, the quantity and the movability of wireless power receivers, etc., Therefore, the power transmission efficiency may be improved in all various operating environments and scenarios.

### BRIEF DESCRIPTION OF THE DRAWINGS

Illustrative, non-limiting example embodiments of the present disclosure will be more clearly understood from the following detailed description taken in conjunction with the accompanying drawings.

FIG. 1 is a block diagram illustrating a wireless power transmission system according to example embodiments.

FIGS. 2A, 2B and 2C are diagrams for describing a first array antenna unit of a first wireless power transmitter included in a wireless power transmission system according to example embodiments.

FIGS. 3A and 3B are block diagrams illustrating an example of a first wireless power transmitter included in a wireless power transmission system according to example embodiments.

FIGS. 4A, 4B and 4C are block diagrams illustrating examples of a first wireless power receiver included in a wireless power transmission system according to example embodiments.

FIGS. 5A, 5B, 5C, 5D and 5E are diagrams for describing an operation of a wireless power transmission system according to example embodiments.

FIGS. 6A and 6B are block diagrams illustrating an example of a first wireless power transmitter and an example of a first wireless power receiver included in a wireless power transmission system according to example embodiments.

FIG. 7 is a block diagram illustrating a wireless power transmission system according to example embodiments.

FIGS. 8A, 8B, 8C and 8D are diagrams illustrating a wireless power transmission system according to example embodiments.

FIGS. 9A and 9B are block diagrams illustrating an example of a first wireless power transmitter and an example of a first wireless power receiver included in a wireless power transmission system according to example embodiments.

FIGS. 10A and 10B are diagrams for describing an operation of a wireless power transmission system according to example embodiments.

FIGS. 11A and 11B are block diagrams illustrating examples of a first wireless power transmitter included in a wireless power transmission system according to example embodiments.

FIGS. 12A, 12B and 12C are block diagrams illustrating examples of a first wireless power receiver included in a wireless power transmission system according to example embodiments.

FIG. 13 is a block diagram illustrating a wireless power transmission system according to example embodiments.

FIG. 14 is a block diagram illustrating a wireless power transmission system according to example embodiments.

FIGS. 15A, 15B and 15C are diagrams for describing a first array antenna unit of a first wireless power transmitter included in a wireless power transmission system according to example embodiments.

FIGS. 16 and 17 are block diagrams illustrating a wireless power transmission system according to example embodiments.

FIGS. 18 and 19 are block diagrams illustrating a wireless power transmission system according to example embodiments.

FIG. 20 is a flowchart illustrating a method of operating a wireless power transmission system according to example embodiments.

### DETAILED DESCRIPTION OF THE EMBODIMENTS

Various example embodiments of the present disclosure will be described more fully hereinafter with reference to the accompanying drawings. The present disclosure may, however, be embodied in many different forms and should not be construed as limited to the embodiments set forth herein. Like reference numerals may refer to like elements throughout this application. FIG. 1 is a block diagram illustrating a wireless power transmission system according to example embodiments.

Referring to FIG. 1, a wireless power transmission system 10 includes a first wireless power transmitter 100 and a first wireless power receiver 500.

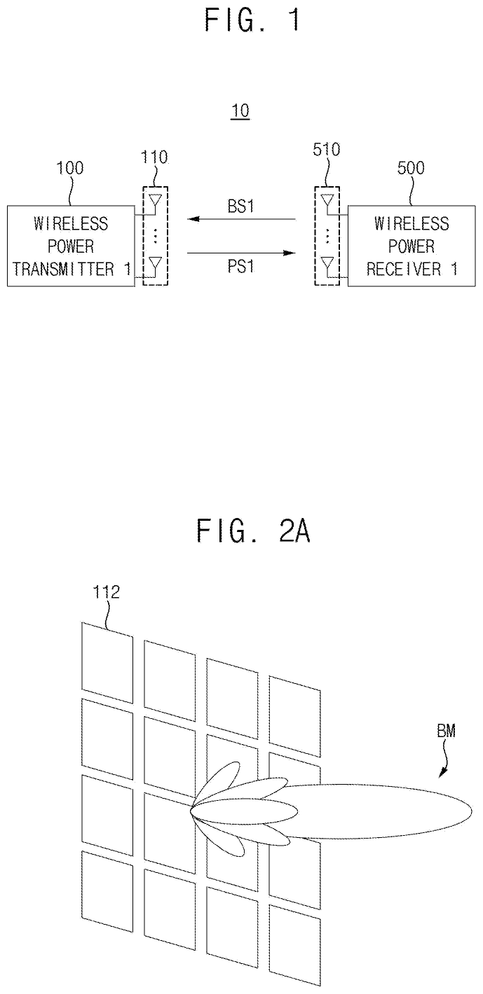

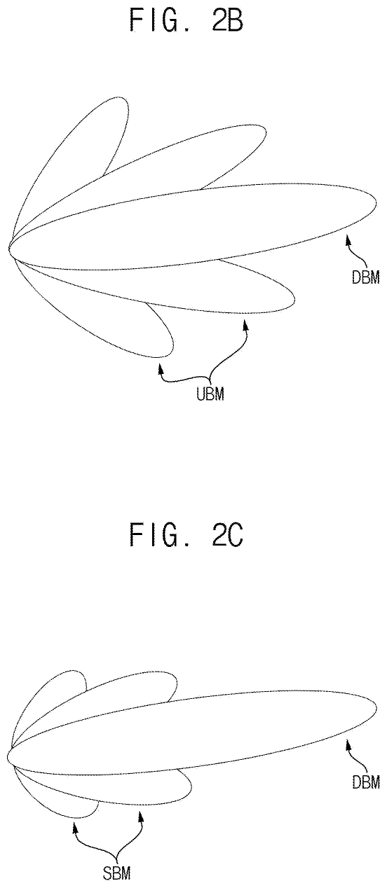

The first wireless power transmitter 100 includes a first array antenna unit 110. The first array antenna unit 110 includes a plurality of antennas that are arranged in a two-dimensional (2D) matrix (or array) formation. A detailed configuration and an operation of the first array antenna unit 110 will be described with reference to FIGS. 2A, 2B and 2C.

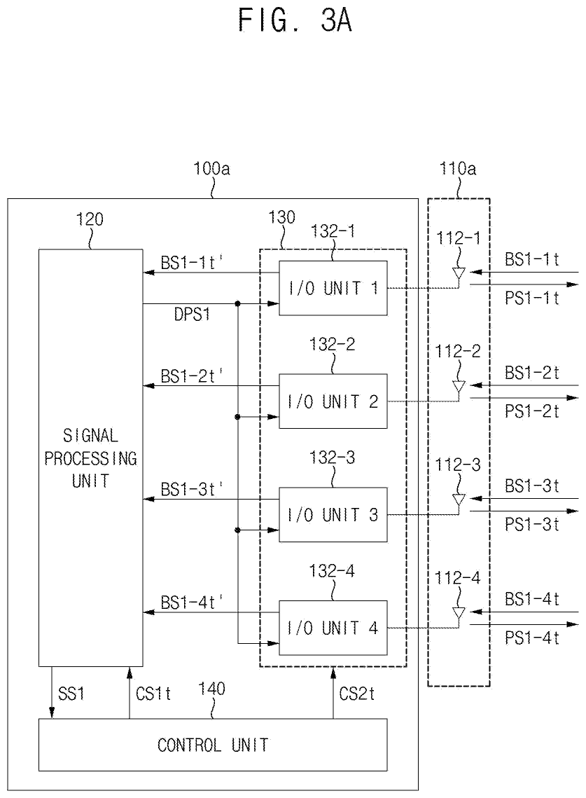

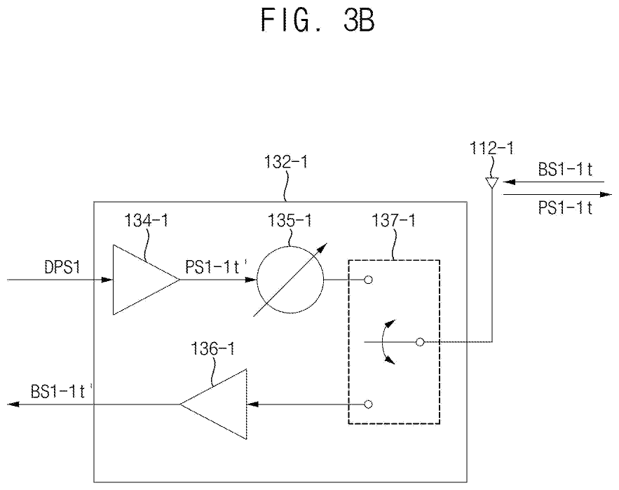

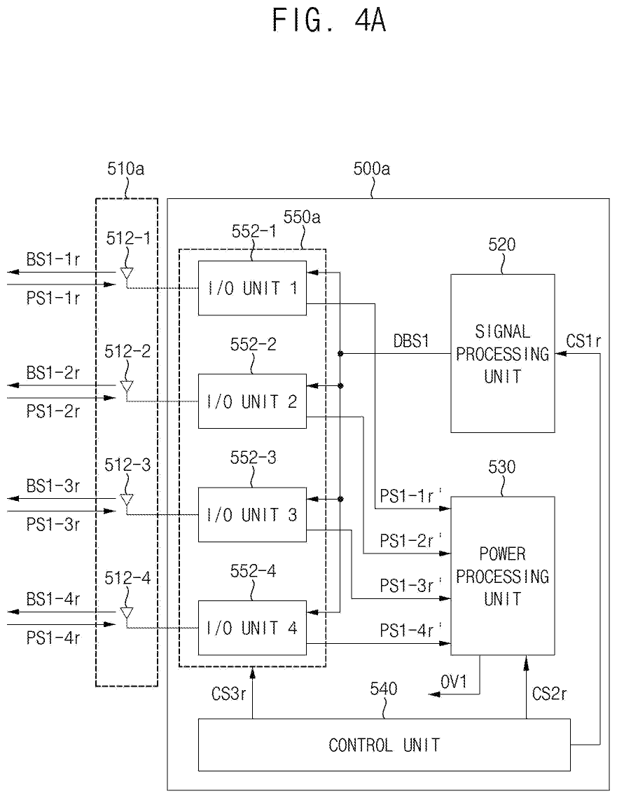

The first wireless power transmitter 100 receives a first beacon signal BS1 provided from the first wireless power receiver 500 through the first array antenna unit 110. The first wireless power transmitter 100 estimates a characteristic or a plurality of characteristics of a first wireless channel based on the first beacon signal BS1. The first wireless channel is a wireless channel between the first wireless power transmitter 100 and the first wireless power receiver 500. The first wireless power transmitter 100 generates a plurality of first power signals PS1 based on the characteristics of the first wireless channel and a time reversal algorithm. The phases and amplitudes of the plurality of first power signals PS1 are adjusted based on the characteristics of the first wireless channel and the time reversal algorithm. The first wireless power transmitter 100 outputs the plurality of first power signals PS1 through the first array antenna unit 110. Detailed configurations of the first wireless power transmitter 100 will be described with reference to FIGS. 3A, 3B, 6A, 9A, 11A, 11B and the like.

To enhance the efficiency of power transmission, a wireless power transmitter may modulate the power signals based on the analysis of a beacon signal received from a wireless power receiver. For example, to transmit the plurality of first power signals PS1 with high efficiency, the first wireless power transmitter 100 may time-reverse a phase of the first beacon signal BS1. Subsequently, the first wireless power transmitter 100 may transmit modulated first power signals PS1 having amplified amplitudes to the first wireless power receiver 500.

The first wireless power receiver 500 includes a first antenna unit 510. The first antenna unit 510 includes at least one antenna. In some example embodiments, as with the first array antenna unit 110, the first antenna unit 510 may include a plurality of antennas that are arranged in a 2D matrix. In other example embodiments, unlike the first array antenna unit 110, the first antenna unit 510 may include only one antenna or may include two or more antennas that are not arranged in a 2D matrix.

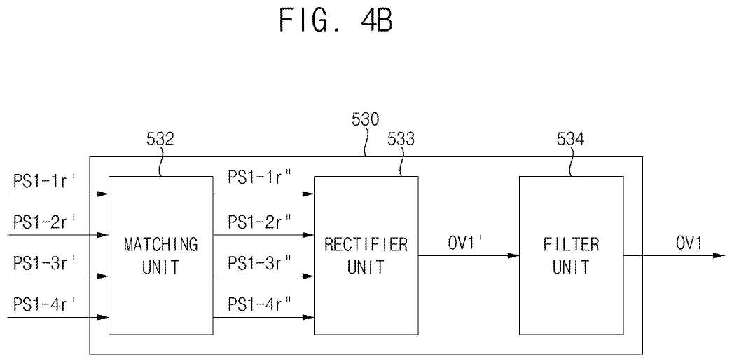

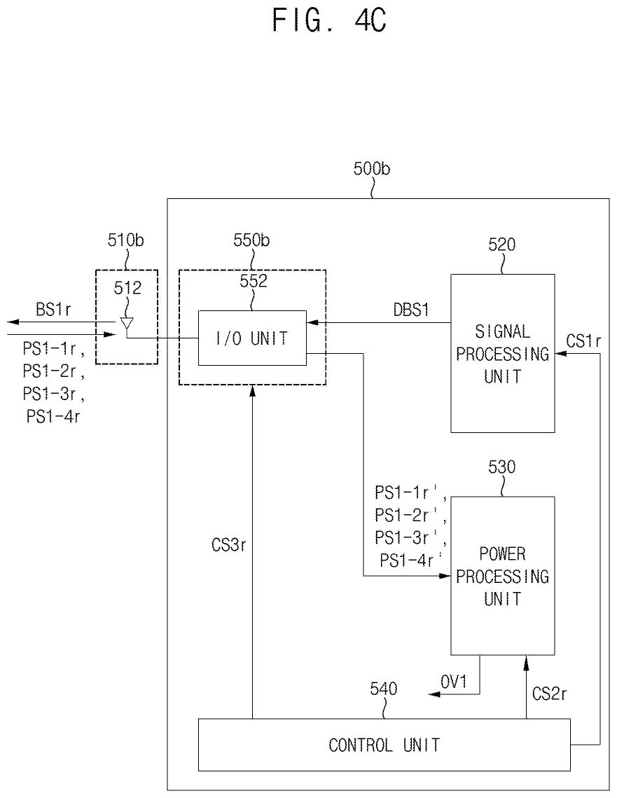

The first wireless power receiver 500 outputs the first beacon signal BS1 through the first antenna unit 510. The first wireless power receiver 500 receives the plurality of first power signals PS1 provided from the first wireless power transmitter 100 through the first antenna unit 510. The first wireless power receiver 500 supplies or receives a first operating voltage (e.g., a first operating voltage OV1 in FIG. 4A) based on the plurality of first power signals PS1. Detailed configurations of the first wireless power receiver 500 will be described with reference to FIGS. 4A, 4B, 4C, 6B, 9B, 12A, 12B, 12C and the like.

A beacon signal refers to a signal transmitted from a wireless power receiver to a wireless power transmitter to enable or facilitate the transmission of power from the wireless power transmitter to the wireless power receiver. For example, the first wireless power transmitter 100 may output the plurality of first power signals PS1 corresponding to the first beacon signal BS1. For example, to transmit the plurality of first power signals PS1, a synchronization between the first wireless power transmitter 100 and the first wireless power receiver 500 may be performed based on the first beacon signal BS1, prior to the transmission of the plurality of first power signals PS1. In other words, the synchronization operation may be a prerequisite step.

In some example embodiments, the first beacon signal BS1 may be transmitted at an initial operation time. For example, the first beacon signal BS1 may be transmitted during an initial operation phase. An initial synchronization may be performed based on the first beacon signal BS1 that is transmitted initially, and the plurality of first power signals PS1 may be transmitted based on a result of the initial synchronization.

In some example embodiments, the first beacon signal BS1 may be transmitted periodically after the initial synchronization. For example, due to the periodic transmission of the first beacon signal BS1, it may be determined that an operating environment is changed. If it is determined that the operating environment is changed, a re-synchronization may be performed, and the plurality of first power signals PS1 may be transmitted based on a result of the re-synchronization.

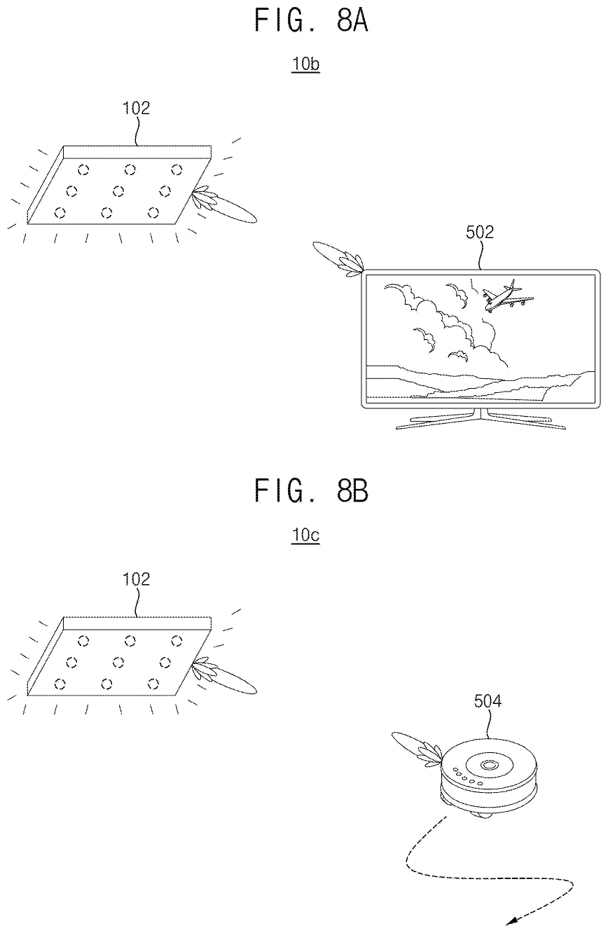

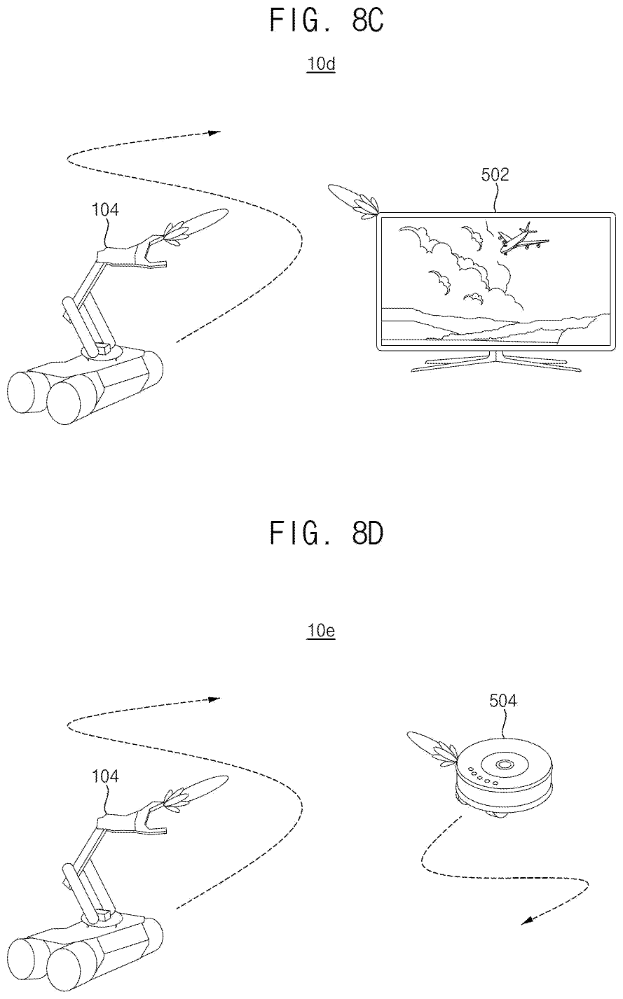

In some example embodiments, in the wireless power transmission system 10, the phases and the amplitudes of the plurality of first power signals PS1 may be adjusted, controlled, and/or modulated differently, based on at least one of 1) the quantity (or number) of wireless power transmitters including the first wireless power transmitter 100, 2) the quantity of wireless power receivers including the first wireless power receiver 500, 3) a movability of the first wireless power transmitter 100, and 4) a movability of the first wireless power receiver 500. Although FIG. 1 illustrates an example where the wireless power transmission system 10 includes one wireless power transmitter 100 and one wireless power receiver 500, example embodiments are not limited thereto. For example, the wireless power transmission system 10 may include two or more wireless power transmitters and/or two or more wireless power receivers, as will be described with reference to FIGS. 14, 16, 18, and 19. Detailed configurations of cases in which each of the first wireless power transmitter 100 and the first wireless power receiver 500 has mobility will be described with reference to FIGS. 8A, 8B, 8C and 8D.

FIGS. 2A, 2B and 2C are diagrams for describing a first array antenna unit of a first wireless power transmitter included in a wireless power transmission system according to example embodiments.

Referring to FIGS. 1 and 2A, the first array antenna unit 110 included in the first wireless power transmitter 100 may include a plurality of antennas 112 that are arranged in a 2D matrix. For convenience of illustration, sixteen (=4*4) antennas 112 are illustrated in FIG. 2A, but example embodiments are not limited thereto.

A plurality of beams BM may be output from the plurality of antennas 112. For example, the plurality of antennas 112 may be arranged, and the plurality of beams BM may be radiated in a desired direction by gain difference and phase difference between respective channels in the array.

Referring to FIGS. 2B and 2C, an operation of adjusting a radiation direction of the plurality of beams BM are illustrated.

As illustrated in FIG. 2B, when all of the antennas emit beams of the same size in different directions, energy may be wasted. For example, energy may not be concentrated when a beam DBM in a desired direction and beams UBM in undesired directions radiate to the same magnitude.

In contrast, as illustrated in FIG. 2C, the beam DBM in the desired direction may be maintained, the beams UBM in the undesired directions may be converted into suppressed beams SBM by adjusting their gains and phases, and thus, energy may be efficiently concentrated in the desired direction.

When an array antenna is not used, e.g., in an isotropic antenna, energy may be radiated uniformly in all directions, and an energy radiation pattern may be determined by an antenna pattern. In contrast, when an array antenna is used, the energy radiation pattern may become more focused, enabling the transmission of concentrated energy. Additionally, the direction of energy radiation direction may be adjusted. For example, the greater the number of antennas in the array, the more energy may be condensed and transmitted.

FIGS. 3A and 3B are block diagrams illustrating an example of a first wireless power transmitter included in a wireless power transmission system according to example embodiments.

Referring to FIG. 3A, a first wireless power transmitter 100a may include a first array antenna unit 110a, a signal processing unit 120, a transceiver unit 130 and a control unit 140. The signal processing unit 120, the transceiver unit 130 and the control unit 140 may each be implemented in hardware as a circuit.

The first array antenna unit 110a may include a plurality of antennas 112-1, 112-2, 112-3 and 112-4. As described with reference to FIG. 2A, the plurality of antennas 112-1 to 112-4 may be arranged in a 2D matrix. Although FIG. 3A illustrates that the first array antenna unit 110a includes four antennas 112-1 to 112-4, example embodiments are not limited thereto.

The plurality of antennas 112-1 to 112-4 may receive a plurality of first beacon signals BS1-1t, BS1-2t, BS1-3t and BS1-4t, and may output a plurality of first power signals PS1-1t, PS1-2t, PS1-3t and PS1-4t. The plurality of first beacon signals BS1-1t to BS1-4t may be included in the first beacon signal BS1 of FIG. 1, and the plurality of first power signals PS1-1t to PS1-4t may be included in the plurality of first power signals PS1 of FIG. 1. For example, the first beacon signal BS1-1t may represent a signal component that is received by the antenna 112-1 among the first beacon signal BS1, and the first power signal PS1-1t may represent a signal component that is output from the antenna 112-1 among the plurality of first power signals PS1. The letter ‘t’ written at the end of reference symbols in FIG. 3A may denote that each signal is input to and output from the transmitter-side (e.g., the first wireless power transmitter 100a).

The signal processing unit 120 may generate a first default (or basic) power signal DPS1 that corresponds to the plurality of first power signals PS1-1t to PS1-4t, and may provide the first default power signal DPS1 to the transceiver unit 130. For example, the first default power signal DPS1 may be an alternating current (AC) signal having a constant amplitude and a constant phase.

The first default power signal DPS1 may include an electromagnetic wave within various frequency spectra. For example, the first default power signal DPS1 may include an electromagnetic wave in a radio frequency range or a microwave frequency range. The first default power signal DPS1, which has a domain of a radio frequency or a microwave frequency, may reduce interference to other communication devices. For example, the first default power signal DPS1 may have a frequency with a domain that corresponds to an industrial scientific medical (ISM) band.

The signal processing unit 120 may receive a plurality of first reception beacon signals BS1-1t′, BS1-2t′, BS1-3t′ and BS1-4t′ that correspond to the plurality of first beacon signals BS1-1t to BS1-4t, respectively. The signal processing unit 120 may generate a first sensing signal SS1 by detecting phases and amplitudes of the plurality of first beacon signals BS1-1t to BS1-4t (e.g., by detecting the phase and the amplitude of the first beacon signal BS1 in FIG. 1).

The transceiver unit 130 may generate the plurality of first power signals PS1-1t to PS1-4t by modulating the first default power signal DPS1 such that the phase of the first default power signal DPS1 is time-reversed and the amplitude of the first default power signal DPS1 is amplified.

For example, the transceiver unit 130 may modulate the first default power signal DPS1 such that the phase of the first default power signal DPS1 corresponds to a time-reversal phase of the plurality of first beacon signals BS1-1t to BS1-4t. In other words, the transceiver unit 130 may modulate the first default power signal DPS1 so that the phase of the first default power signal DPS1 aligns with the time-reversed phase of the plurality of first beacon signals BS1-1t to BS1-4t. For example, the time-reversal phase may be obtained by the complex conjugation of a wave. For example, the time-reversal phase may be obtained by reversing a phase of a wave by as much as about π/2.

For example, the transceiver unit 130 may amplify the amplitude of the first default power signal DPS1. In terms of transmission of the plurality of first power signals PS1-1t to PS1-4t having the time-reversal phase, an extent of the amplitude of the plurality of first beacon signals BS1-1t to BS1-4t may be associated with or related to the efficiency of power transmission. The first wireless power transmitter 100a may have a limited amount of total transmissible power, and thus, a phase and amplitude control algorithm may be required for efficient power transmission. For example, the phase and amplitude control algorithm may control an amplitude factor of the plurality of first power signals PS1-1t to PS1-4t, based on the extent of the amplitude of the plurality of first beacon signals BS1-1t to BS1-4t. For example, when an amplitude of a beacon signal received by a specific antenna is relatively large, the phase and amplitude control algorithm may be implemented such that a power signal with a relatively large amplitude is output from that antenna.

The transceiver unit 130 may provide the plurality of first reception beacon signals BS1-1t′ to BS1-4t′ corresponding to the plurality of first beacon signals BS1-1t to BS1-4t to the signal processing unit 120.

The transceiver unit 130 may include a plurality of input/output (I/O) units 132-1, 132-2, 132-3 and 132-4. For example, the I/O unit 132-1 may be connected to the antenna 112-1, may provide the first reception beacon signal BS1-1t′ corresponding to the first beacon signal BS1-1t to the signal processing unit 120. In addition, the I/O unit 132-1 may generate the first power signal PS1-1t by modulating the first default power signal DPS1 such that the phase of the first default power signal DPS1 is time-reversed and the amplitude of the first default power signal DPS1 is amplified.

In some example embodiments, as illustrated in FIG. 3A, the number of the plurality of I/O units 132-1 to 132-4 and the number of the plurality of antennas 112-1 to 112-4 may be equal to each other. In other words, the plurality of I/O units 132-1 to 132-4 and the plurality of antennas 112-1 to 112-4 may be in one-to-one correspondence, and one antenna may be connected to one I/O unit. In other example embodiments, the number of the plurality of I/O units and the number of the plurality of antennas may be different from each other. In other words, the plurality of I/O units and the plurality of antennas may be in one-to-many correspondence. For example, two or more antennas may be connected to one I/O unit.

The control unit 140 may control operations of the signal processing unit 120 and the transceiver unit 130. For example, the control unit 140 may generate a first control signal CS1t for controlling the signal processing unit 120 and a second control signal CS2t for controlling the transceiver unit 130. For example, the control unit 140 may generate the second control signal CS2t based on the first sensing signal SS1. This enables the transceiver unit 130 to perform the phase and amplitude control algorithm based on the second control signal CS2t. Subsequently, the control unit 140 may provide the second control signal CS2t to the transceiver unit 130.

In some example embodiments, the signal processing unit 120 may include a radio frequency integrated circuit (RFIC). In some example embodiments, the control unit 140 may include a microprocessor. In some example embodiments, the signal processing unit 120 and the control unit 140 may further include at least one analog-digital logic circuit.

Referring to FIG. 3B, the I/O unit 132-1 may include a power amplifier 134-1, a phase shifter 135-1, a low noise amplifier 136-1 and a switch circuit 137-1.

The power amplifier 134-1 may adjust the amplitude of the first default power signal DPS1. For example, the power amplifier 134-1 may amplify the first default power signal DPS1. The phase shifter 135-1 may generate the first power signal PS1-1t by adjusting a phase of an output signal PS1-1t′ of the power amplifier 134-1.

The low noise amplifier 136-1 may generate the first reception beacon signal BS1-1t′ by adjusting the amplitude of the first beacon signal BS1-1t (e.g., by amplifying the first beacon signal BS1-1t).

The switch circuit 137-1 may connect one of the phase shifter 135-1 and the low noise amplifier 136-1 with the antenna 112-1. For example, when the first beacon signal BS1-1t is received through the antenna 112-1, the switch circuit 137-1 may electrically connect the low noise amplifier 136-1 with the antenna 112-1. For example, when the first power signal PS1-1t is to be output, the switch circuit 137-1 may electrically connect the phase shifter 135-1 with the antenna 112-1. For example, the switch circuit 137-1 may include a single pole double throw (SPDT) switch.

Each of the I/O units 132-2, 132-3 and 132-4 may have a configuration substantially the same as that of the I/O unit 132-1 of FIG. 3B.

FIGS. 4A, 4B and 4C are block diagrams illustrating examples of a first wireless power receiver included in a wireless power transmission system according to example embodiments.

Referring to FIG. 4A, a first wireless power receiver 500a may include a first antenna unit 510a, a signal processing unit 520, a power processing unit 530, a control unit 540 and a transceiver unit 550a. The signal processing unit 520, the power processing unit 530, the control unit 540 and the transceiver unit 550a may each be implemented in hardware as a circuit.

The first antenna unit 510a may include a plurality of antennas 512-1, 512-2, 512-3 and 512-4. Like with that described with reference to FIG. 2A, the plurality of antennas 512-1 to 512-4 may be arranged in a 2D matrix. Like the example of FIG. 3A, although FIG. 4A illustrates that the first antenna unit 510a includes four antennas 512-1 to 512-4, example embodiments are not limited thereto.

The plurality of antennas 512-1 to 512-4 may output a plurality of first beacon signals BS1-1r, BS1-2r, BS1-3r and BS1-4r, and may receive a plurality of first power signals PS1-1r, PS1-2r, PS1-3r and PS1-4r. The plurality of first beacon signals BS1-Ir to BS1-4r may be included in the first beacon signal BS1 of FIG. 1, and the plurality of first power signals PS1-1r to PS1-4r may be included in the plurality of first power signals PS1 of FIG. 1. For example, the first beacon signal BS1-Ir may represent a signal component that is output from the antenna 512-1 among the first beacon signal BS1, and the first power signal PS1-Ir may represent a signal component that is received by the antenna 512-1 among the plurality of first power signals PS1. The letter ‘r’ written at the end of reference symbols in FIG. 4A may denote that each signal is input to and output from the receiver-side (e.g., the first wireless power receiver 500a).

The signal processing unit 120 may generate a first default beacon signal DBS1 that corresponds to the plurality of first beacon signals BS1-Ir to BS1-4r, and may provide the first default beacon signal DBS1 to the transceiver unit 550a.

The power processing unit 530 may receive a plurality of first reception power signals PS1-1r′, PS1-2r′, P1-3r′ and PS1-4r′ that correspond to the plurality of first power signals PS1-1r to PS1-4r, respectively. The power processing unit 530 may generate a first operating (or driving) voltage OV1 based on the plurality of first power signals PS1-1r to PS1-4r (e.g., based on or in response to the plurality of first reception power signals PS1-1r′ to PS1-4r′. The first operating voltage OV1 may be supplied as a power supply voltage to the first wireless power receiver 500a and the components 510a, 520, 540 and 550a included therein.

The transceiver unit 550a may generate the plurality of first beacon signals BS1-1r to BS1-4r based on the first default beacon signal DBS1. The transceiver unit 550a may provide the plurality of first reception power signals PS1-1r′ to PS1-4r′, which correspond to the plurality of first power signals PS1-1r to PS1-4r, to the power processing unit 530.

The transceiver unit 550a may include a plurality of I/O units 552-1, 552-2, 552-3 and 552-4. For example, the I/O unit 552-1 may be connected to the antenna 512-1, may generate the first beacon signal BS1-Ir based on the first default beacon signal DBS1, and may provide the first reception power signal PS1-Ir′ corresponding to the first power signal PS1-Ir to the power processing unit 530.

In some example embodiments, each of the plurality of I/O units 552-1 to 552-4 may be implemented as described with reference to FIG. 3B. In some example embodiments, as illustrated in FIG. 4A, the plurality of I/O units 552-1 to 552-4 and the plurality of antennas 512-1 to 512-4 may be in one-to-one correspondence. In other example embodiments, the plurality of I/O units and the plurality of antennas may be in one-to-many correspondence,

The control unit 540 may control operations of the signal processing unit 520, the power processing unit 530 and the transceiver unit 550a. For example, the control unit 540 may generate a first control signal CS1r for controlling the signal processing unit 520, a second control signal CS2r for controlling the power processing unit 530, and a third control signal CS3r for controlling the transceiver unit 550a.

Referring to FIG. 4B, the power processing unit 530 may include a matching unit 532, a rectifier unit 533 and a filter unit 534. Each of the matching unit 532, the rectifier unit 533 and the filter unit 534 can be implemented in hardware as a circuit.

The matching unit 532 may perform impedance matching associated with the plurality of first reception power signals PS1-1r′ to PS1-4r′. The rectifier unit 533 may rectify output signals PS1-1r″, PS1-2r″, P1-3r″ and PS1-4r″ of the matching unit 532, which are AC signals, into a direct current (DC) voltage OV1′. The filter unit 534 may generate the first operating voltage OV1 by filtering the output signal OV1′ of the rectifier unit 533.

In some example embodiments, the power processing unit 530 may further include a power management unit having a maximum power point tracking structure that can increase power receiving efficiency to a maximum, a DC converter unit that can safely supply the first operating voltage OV1 by boosting or adjusting a voltage, and/or the like.

Referring to FIG. 4C, a first wireless power receiver 500b may include a first antenna unit 510b, a signal processing unit 520, a power processing unit 530, a control unit 540 and a transceiver unit 550b.

The first wireless power receiver 500b may be substantially the same as the first wireless power receiver 500a of FIG. 4A, except that configurations of the first antenna unit 510b and the transceiver unit 550b are changed.

The first antenna unit 510b may include a single antenna 512. The antenna 512 may output a first beacon signal BS1r, and may receive a plurality of first power signals (PS1-1r, PS1-2r, PS1-3r and PS1-4r. The first beacon signal BS1r may correspond to the first beacon signal BS1 of FIG. 1, and the plurality of first power signals PS1-Ir to PS1-4r may correspond to the plurality of first power signals PS1 of FIG. 1.

The transceiver unit 550b may generate the first beacon signal BS1r based on the first default beacon signal DBS1. The transceiver unit 550b may provide a plurality of first reception power signals PS1-1r′, PS1-2r′, PS1-3r′ and PS1-4r′, which correspond to the plurality of first power signals PS1-1r to PS1-4r, to the power processing unit 530. The transceiver unit 550b may include an I/O unit 552. The I/O unit 552 may have a structure simpler than that described with reference to FIG. 3B (e.g., a structure in which a phase shifter is omitted).

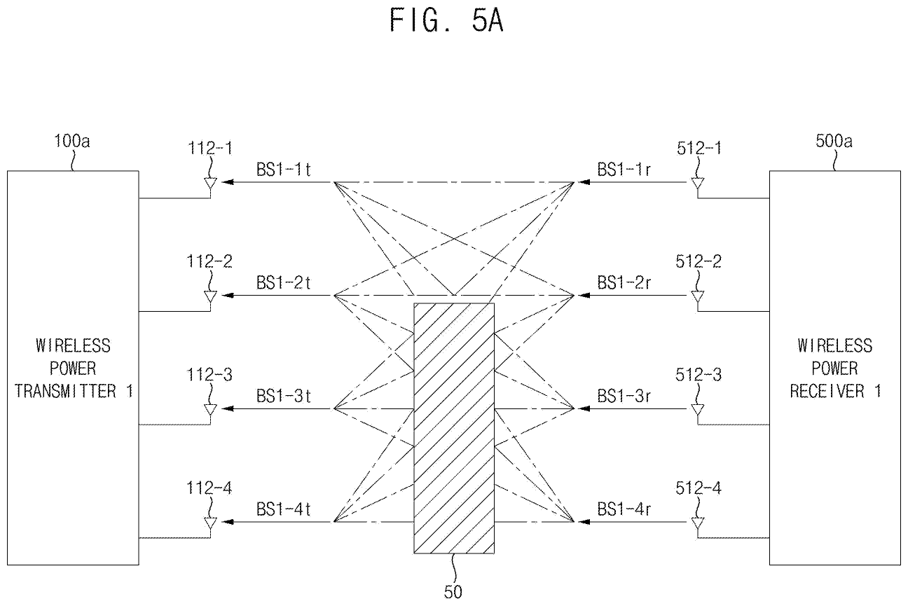

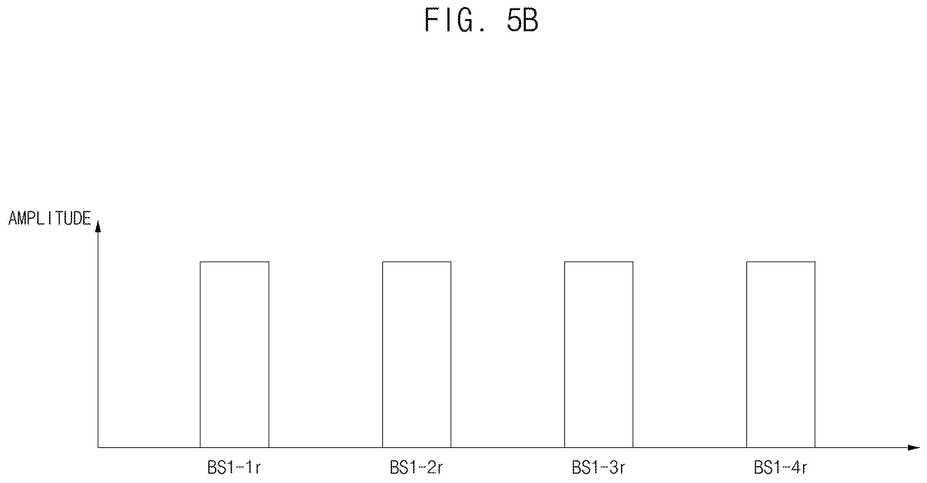

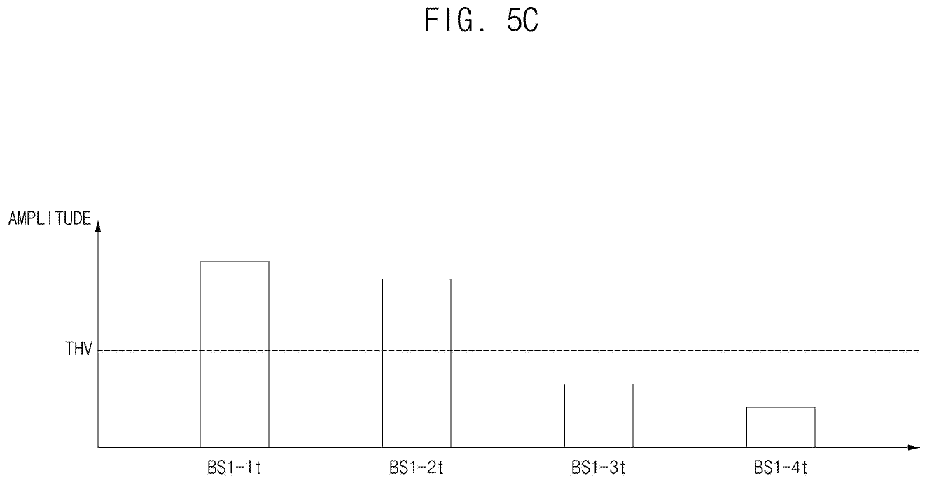

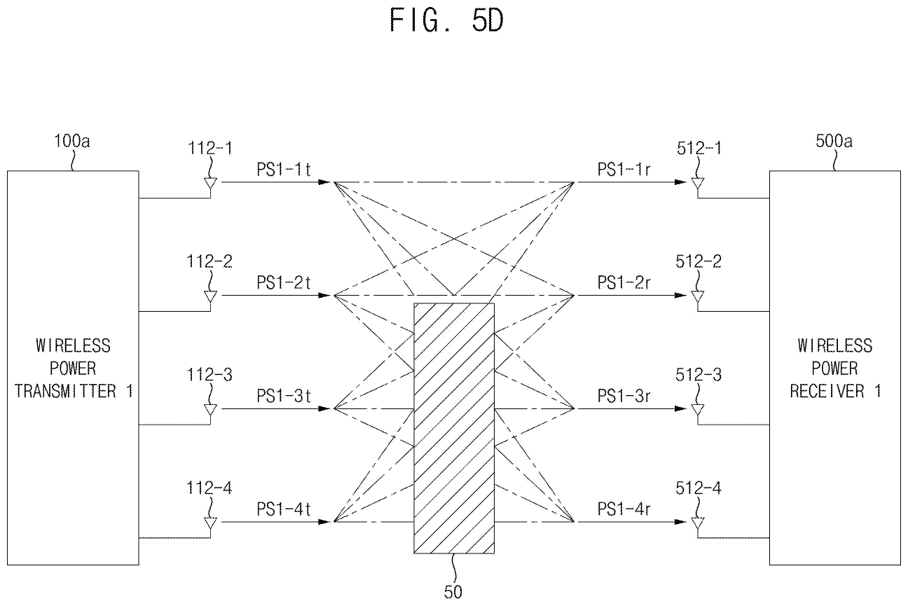

FIGS. 5A, 5B, 5C, 5D and 5E are diagrams for describing an operation of a wireless power transmission system according to example embodiments.

Referring to FIGS. 5A, 5B and 5C, an operation of transmitting the first beacon signal BS1 between the first wireless power transmitter 100a of FIG. 3A and the first wireless power receiver 500a of FIG. 4A is illustrated. For example, the first wireless power transmitter 100a may include four antennas 112-1 to 112-4, and the first wireless power receiver 500a may include four antennas 512-1 to 512-4.

To perform the synchronization operation, the first wireless power receiver 500a may output the plurality of first beacon signals BS1-Ir to BS1-4r through the antennas 512-1 to 512-4, and the first wireless power transmitter 100a may receive the plurality of first beacon signals BS1-1t to BS1-4t through the antennas 112-1 to 112-4.

For example, as illustrated in FIG. 5A, an obstacle 50 may exist between the first wireless power transmitter 100a and the first wireless power receiver 500a. In this example, even if all of the plurality of first beacon signals BS1-Ir to BS1-4r output from the first wireless power receiver 500a have the same amplitude as illustrated in FIG. 5B, the plurality of first beacon signals BS1-1t to BS1-4t received by the first wireless power transmitter 100a may have different amplitudes depending on positions (or locations) of the antennas 112-1 to 112-4 and a position (or location) of the obstacle 50 as illustrated in FIG. 5C. For example, as illustrated in FIG. 5C, the first beacon signals BS1-1t and BS1-2t received through the antennas 112-1 and 112-2, which are relatively less affected by the obstacle 50, may have relatively large amplitudes. However, the first beacon signals BS1-3t and BS1-4t received through the antennas 112-3 and 112-4, which are relatively more affected by the obstacle 50, may have relatively small amplitudes. For example, the amplitudes of the first beacon signals BS1-1t and BS1-2t may be greater than a threshold value THV, and the amplitudes of the first beacon signals BS1-3t and BS1-4t may be smaller than the threshold value THV.

Referring to FIGS. 5D and 5E, an operation of transmitting the plurality of first power signal PS1 between the first wireless power transmitter 100a and the first wireless power receiver 500a is illustrated, when the first beacon signal BS1 is transmitted as illustrated in FIGS. 5A, 5B and 5C.

The first wireless power transmitter 100a may output the plurality of first power signals PS1-1t to PS1-4t through the antennas 112-1 to 112-4 by applying the phase and amplitude control algorithm based on the plurality of first beacon signals BS1-1t to BS1-4t, and the first wireless power receiver 500a may receive the plurality of first power signals PS1-1r to PS1-4r through the antennas 512-1 to 512-4.

For example, the first default power signal DPS1 may be modulated such that the phase of the first default power signal DPS1 corresponds to the time-reversal phase of the plurality of first beacon signals BS1-1t to BS1-4t. Consequently, the amplitude of the first default power signal DPS1 may be amplified, and thus, the plurality of first power signals PS1-1t to PS1-4t may be generated. For example, the first wireless power transmitter 100a may have a limited amount of total transmissible power, and thus, the amplitudes of the plurality of first power signals PS1-1t to PS1-4t may be adjusted based on the amplitudes of the plurality of first beacon signals BS1-1t to BS1-4t. Consequently, a power signal with a relatively large amplitude is output from a specific antenna when an amplitude of a beacon signal received by that antenna is relatively large.

Since the power signal is modulated to have the time-reversal phase of the beacon signal, the power signal may be transmitted to the wireless power receiver with high efficiency. This is because, the power signal satisfies conditions of constructive interference at wireless power receiver's location when the beacon signal is sent to the wireless power transmitter.

For example, when the first beacon signals BS1-1t and BS1-2t have relatively large amplitudes and the first beacon signals BS1-3t and BS1-4t have relatively small amplitudes as illustrated in FIG. 5C, the plurality of first power signals PS1-1t to PS1-4t may be generated such that the first power signals PS1-1t and PS1-2t output through the antennas 112-1 and 112-2 have relatively large amplitudes and the first power signals PS1-3t and PS1-4t output through the antennas 112-3 and 112-4 have relatively small amplitudes as illustrated in FIG. 5E. In addition, the phases of the plurality of first power signals PS1-1t to PS1-4t may also be adjusted in consideration of the position of the obstacle 50.

In some example embodiments, as illustrated in FIG. 5E, all of the first power signals PS1-1t to PS1-4t may have amplitudes greater than an amplitude A1 of the first default power signal DPS1. In addition, an amplitude factor of the amplitudes (e.g., the amount of increase in the amplitudes) of the first power signals PS1-1t to PS1-4t may be set differently depending on the amplitudes of the corresponding first beacon signals BS1-1t to BS1-4t. For example, the amplitude of the first power signal PS1-1t may be obtained by adding an amplitude A21 to the amplitude A1 of the first default power signal DPS1. Since the amplitude of the first beacon signal BS1-2t is smaller than the amplitude of the first beacon signal BS1-1t, the amplitude of the first power signal PS1-2t may be obtained by adding an amplitude A22, which is smaller than the amplitude A21, to the amplitude A1 of the first default power signal DPS1. Since the amplitude of the first beacon signal BS1-3t is smaller than the amplitude of the first beacon signal BS1-2t, the amplitude of the first power signal PS1-3t may be obtained by adding an amplitude A23, which is smaller than the amplitude A22, to the amplitude A1 of the first default power signal DPS1. Since the amplitude of the first beacon signal BS1-4t is smaller than the amplitude of the first beacon signal BS1-3t, the amplitude of the first power signal PS1-4t may be obtained by adding an amplitude A24, which is smaller than the amplitude A23, to the amplitude A1 of the first default power signal DPS1. In other words, the amplitudes A21 to A24 may be determined depending on the amplitudes of the first beacon signals BS1-1t to BS1-4t. The power signals may be modulated by adjusting the amplitude factor of the amplitudes. This way, an antenna receiving a beacon signal with a large amplitude can transmit a power signal with a large amplitude, thereby leading to an improvement in the efficiency of power transmission.

In some example embodiments, only the amplitudes of the first power signals PS1-1t and PS1-2t, which correspond to the first beacon signals BS1-1t and BS1-2t having amplitudes greater than the threshold value THV, may be amplified or increased. The amplitudes of the first power signals PS1-3t and PS1-4t, which correspond to the first beacon signals BS1-3t and BS1-4t having amplitudes smaller than the threshold value THV, may not be amplified and may be maintained.

Although FIGS. 5A and 5D illustrate that signals are transmitted along straight lines (e.g., alternated long and short dash lines) between the antennas 112-1 to 112-4 and the antennas 512-1 to 512-4, example embodiments are not limited thereto. For example, signals may be transmitted between the first wireless power transmitter 100a and the first wireless power receiver 500a via all available paths therebetween. For example, the signals may be directly transmitted along a path of a line of sight between the first wireless power transmitter 100a and the first wireless power receiver 500a. As another example, the signals may be directly and/or indirectly transmitted by reflection, diffraction and refraction, according to a path that varies with respect to the line of sight.

In some example embodiments, the synchronization operation of FIGS. 5A, 5B and 5C may be performed once, and then, the power transmission operation of FIGS. 5D and 5E may be performed continuously and repeatedly.

In some example embodiments, the synchronization operation of FIGS. 5A, 5B and 5C may be performed periodically, and thus, the power transmission operation of FIGS. 5D and 5E may be performed continuously and repeatedly.

In some example embodiments, when a change in the operating environment (e.g., a channel environment) is detected, the phases and the amplitudes of the plurality of first power signals PS1-1t to PS1-4t may be re-adjusted by changing the phase and amplitude control algorithm and by finely adjusting the amplitude factor in real time. A change in the operating environment may correspond to, for example, when a first power transmission efficiency between the first wireless power transmitter 100a and the first wireless power receiver 500a becomes lower than a reference power transmission efficiency while periodically performing the synchronization operation.

In some example embodiments, when the change in the operating environment (e.g., the channel environment) is detected, at least one of the antennas 112-1 to 112-4 in the first wireless power transmitter 100a and the antennas 512-1 to 512-4 in the first wireless power receiver 500a may be aligned. For example, a position and/or a direction of at least one of the antennas 112-1 to 112-4 and 512-1 to 512-4 may be adjusted, or a position and/or a direction of the devices may be adjusted itself. Here, a change in the operating environment may correspond to, for example, when the first power transmission efficiency becomes lower than the reference power transmission efficiency while periodically performing the synchronization operation.

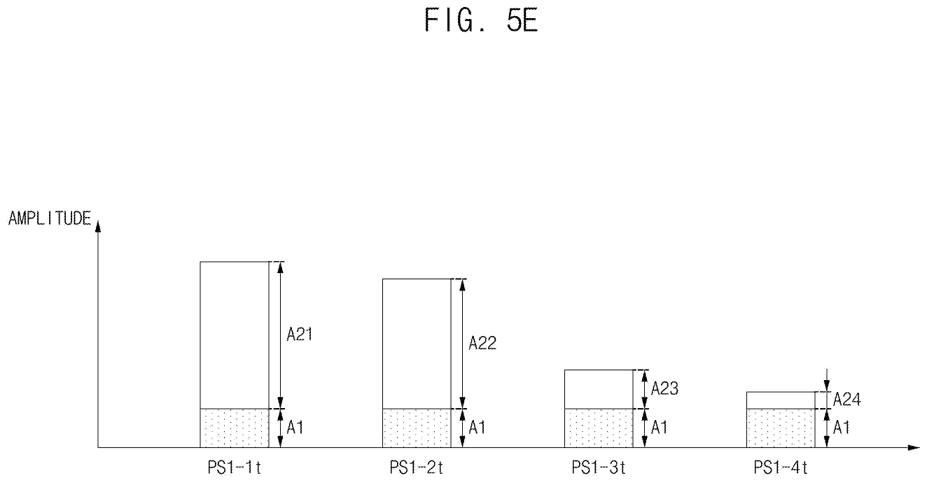

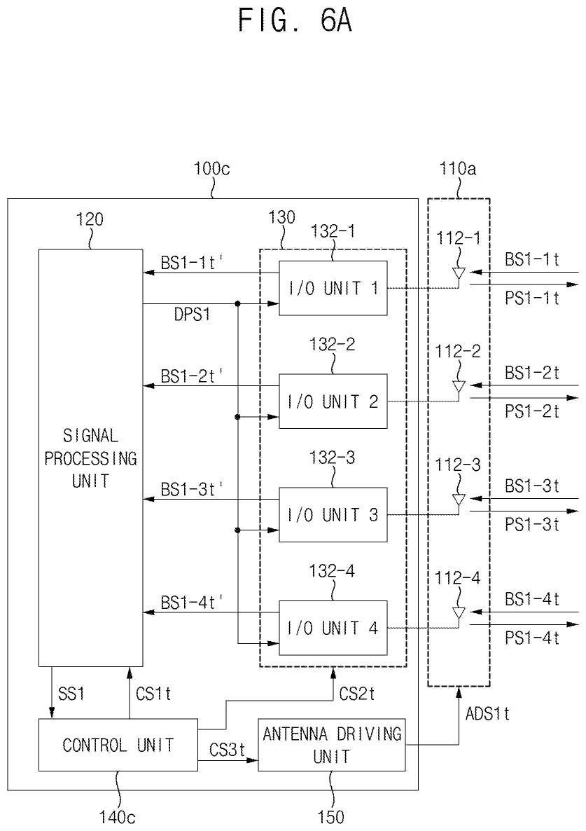

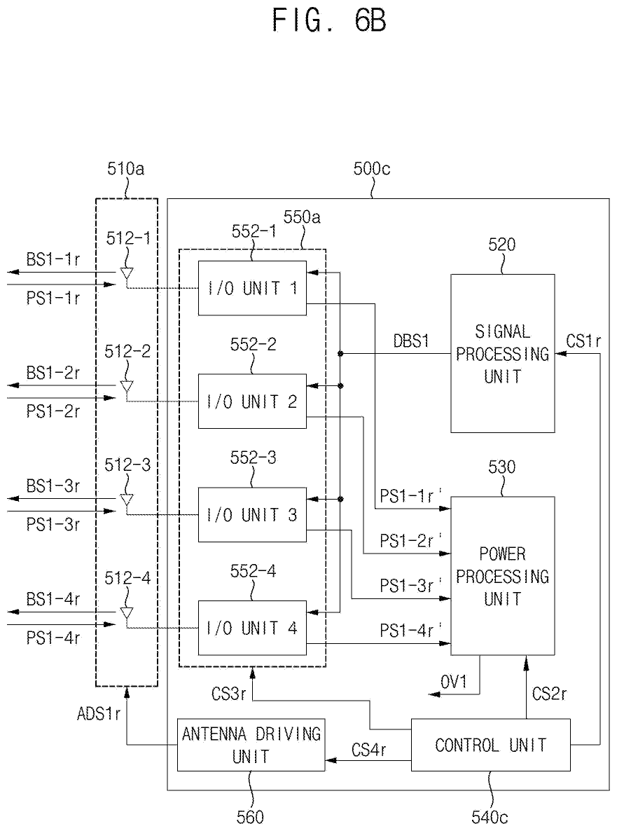

FIGS. 6A and 6B are block diagrams illustrating an example of a first wireless power transmitter and an example of a first wireless power receiver included in a wireless power transmission system according to example embodiments. The descriptions repeated with FIGS. 3A and 4A will be omitted.

Referring to FIG. 6A, a first wireless power transmitter 100c may include a first array antenna unit 110a, a signal processing unit 120, a transceiver unit 130, a control unit 140c and an antenna driving unit 150. Each of the signal processing unit 120, the transceiver unit 130, the control unit 140c and the antenna driving unit 150 may be implemented in hardware as a circuit.

The first wireless power transmitter 100c may be substantially the same as the first wireless power transmitter 100a of FIG. 3A, except that the first wireless power transmitter 100c further includes the antenna driving unit 150.

The control unit 140c may further generate a third control signal CS3t for controlling the antenna driving unit 150. The antenna driving unit 150 may generate an antenna driving signal ADS It based on the third control signal CS3t. In some example embodiments, when the change in the operating environment is detected, the position and/or the direction of at least one of the antennas 112-1 to 112-4 may be controlled or adjusted based on the antenna driving signal ADSIt, and thus, the first wireless power transmitter 100c may be aligned with the first wireless power receiver 500.

Referring to FIG. 6B, a first wireless power receiver 500c may include a first antenna unit 510a, a signal processing unit 520, a power processing unit 530, a control unit 540c, a transceiver unit 550a and an antenna driving unit 560. Each of the signal processing unit 520, the power processing unit 530, the control unit 540c, the transceiver unit 550a and the antenna driving unit 560 may be implemented in hardware as a circuit.

The first wireless power receiver 500c may be substantially the same as the first wireless power receiver 500a of FIG. 4A, except that the first wireless power receiver 500c further includes the antenna driving unit 560.

The control unit 540c may further generate a fourth control signal CS4r for controlling the antenna driving unit 560. The antenna driving unit 560 may generate the antenna driving signal ADS1r based on the fourth control signal CS4r. In some example embodiments, when the change in the operating environment is detected, the position and/or the direction of at least one of the antennas 512-1 to 512-4 may be controlled or adjusted based on the antenna driving signal ADS1r, and thus, the first wireless power receiver 500c may be aligned with the first wireless power transmitter 100.

The first wireless power receiver 500b of FIG. 4C may further include the antenna driving unit 560 in FIG. 6B.

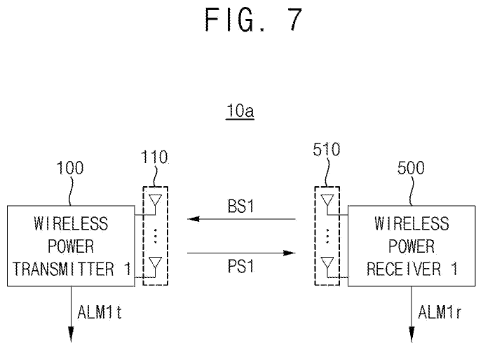

FIG. 7 is a block diagram illustrating a wireless power transmission system according to example embodiments. The descriptions repeated with FIG. 1 will be omitted.

Referring to FIG. 7, a wireless power transmission system 10a includes a first wireless power transmitter 100 and a first wireless power receiver 500.

When the change in the operating environment is detected, e.g., when the first power transmission efficiency between the first wireless power transmitter 100 and the first wireless power receiver 500 becomes lower than the reference power transmission efficiency, the first wireless power transmitter 100 may generate an alarm signal (or warning signal) ALM1t, and/or the first wireless power receiver 500 may generate an alarm signal ALM1r. For example, the alarm signals ALM1t and ALM1r may be output in the form of audio, video and/or vibration. For example, each of the first wireless power transmitter 100 and the first wireless power receiver 500 may include at least one of a display unit, a sound output unit and a vibration motor for generating the alarm signals ALM1t and ALM1r. Based on the alarm signals ALM1t and ALM1r, a user may align the first wireless power transmitter 100 and the first wireless power receiver 500 with each other.

FIGS. 8A, 8B, 8C and 8D are diagrams illustrating a wireless power transmission system according to example embodiments.

Referring to FIG. 8A, a wireless power transmission system 10b includes a first wireless power transmitter 102 and a first wireless power receiver 502. FIG. 8A illustrates an example where both the first wireless power transmitter 102 and the first wireless power receiver 502 are stationary devices or fixed devices whose position is fixed. For example, the first wireless power transmitter 102 may be a lighting device, and the first wireless power receiver 502 may be a digital television (TV), but example embodiments are not limited thereto.

Referring to FIG. 8B, a wireless power transmission system 10c includes a first wireless power transmitter 102 and a first wireless power receiver 504. FIG. 8B illustrates an example where the first wireless power transmitter 102 is a stationary device and the first wireless power receiver 504 is a mobile device whose position is changeable. For example, the first wireless power receiver 504 may be a robot cleaner, but example embodiments are not limited thereto.

Referring to FIG. 8C, a wireless power transmission system 10d includes a first wireless power transmitter 104 and a first wireless power receiver 502. FIG. 8C illustrates an example where the first wireless power transmitter 104 is a mobile device and the first wireless power receiver 502 is a stationary device. For example, the first wireless power transmitter 104 may be a vehicle for wireless power transmission, but example embodiments are not limited thereto.

Referring to FIG. 8D, a wireless power transmission system 10e includes a first wireless power transmitter 104 and a first wireless power receiver 504. FIG. 8D illustrates an example where both the first wireless power transmitter 104 and the first wireless power receiver 504 are mobile devices.

As described with reference to FIGS. 8A, 8B, 8C and 8D, the wireless power transmission system according to example embodiments may be implemented in four scenarios, based on combinations of the movability of the wireless power transmitter (e.g., stationary or mobile device) and the movability of the wireless power receiver (e.g., stationary or mobile device).

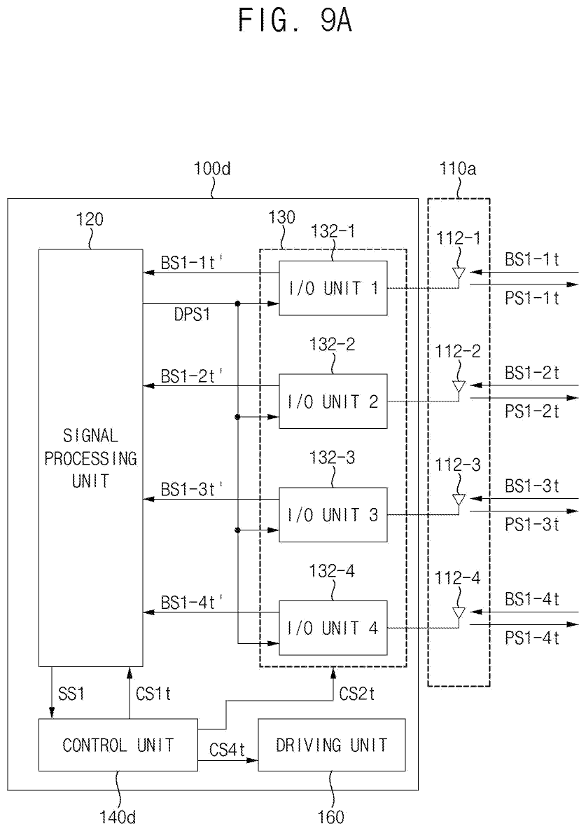

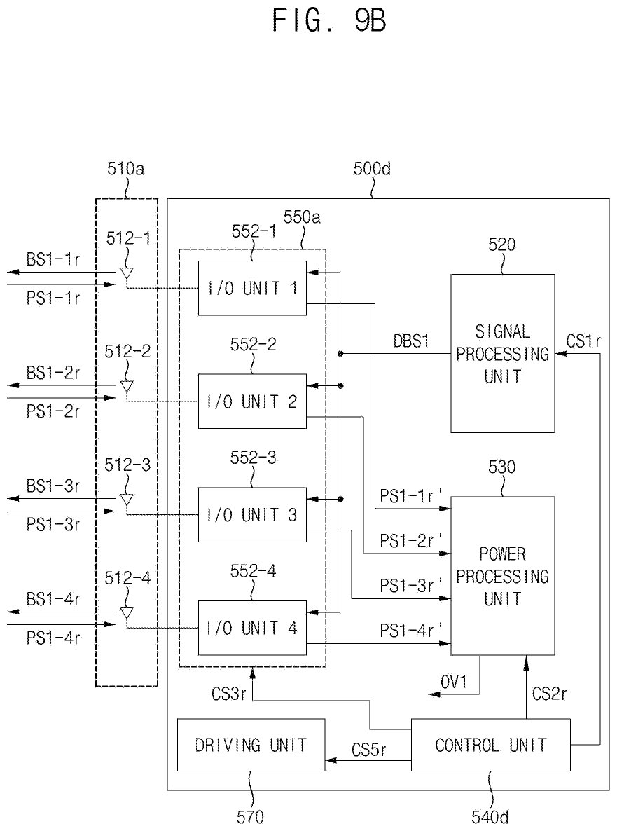

FIGS. 9A and 9B are block diagrams illustrating an example of a first wireless power transmitter and an example of a first wireless power receiver included in a wireless power transmission system according to example embodiments. The descriptions repeated with FIGS. 3A and 4A will be omitted.

Referring to FIG. 9A, a first wireless power transmitter 100d may include a first array antenna unit 110a, a signal processing unit 120, a transceiver unit 130, a control unit 140d and a driving unit 160. For example, the first wireless power transmitter 100d may be a mobile device described with reference to FIGS. 8C and 8D. Each of the signal processing unit 120, the transceiver unit 130, the control unit 140d and the driving unit 160 may be implemented in hardware as a circuit.

The first wireless power transmitter 100d may be substantially the same as the first wireless power transmitter 100a of FIG. 3A, except that the first wireless power transmitter 100d further includes the driving unit 160.

The control unit 140d may further generate a fourth control signal CS4t for controlling the driving unit 160. The driving unit 160 may change or control the position or movement of the first wireless power transmitter 100d based on the fourth control signal CS4t. For example, the driving unit 160 may include an engine/motor unit for acceleration, a brake unit for deceleration, a steering unit and a wheel unit for direction control, etc. In some example embodiments, when the change in the operating environment is detected, the position and/or the direction of the first wireless power transmitter 100d may be controlled or adjusted by the driving unit 160, and thus, the first wireless power transmitter 100d may be aligned with the first wireless power receiver 500.

Referring to FIG. 9B, a first wireless power receiver 500d may include a first antenna unit 510a, a signal processing unit 520, a power processing unit 530, a control unit 540d, a transceiver unit 550a and a driving unit 570. For example, the first wireless power receiver 500d may be a mobile device described with reference to FIGS. 8B and 8D. Each of the signal processing unit 520, the power processing unit 530, the control unit 540d, the transceiver unit 550a and the driving unit 570 may be implemented in hardware as a circuit.

The first wireless power receiver 500d may be substantially the same as the first wireless power receiver 500a of FIG. 4A, except that the first wireless power receiver 500d further includes the driving unit 570.

The control unit 540d may further generate a fifth control signal CS5r for controlling the driving unit 570. The driving unit 570 may change or control the position or movement of the first wireless power receiver 500d based on the fifth control signal CS5r. The driving unit 570 may be implemented similarly to the driving unit 160 in FIG. 9A. In some example embodiments, when the change in the operating environment is detected, the position and/or the direction of the first wireless power receiver 500d may be controlled or adjusted by the driving unit 570, and thus, the first wireless power receiver 500d may be aligned with the first wireless power transmitter 100.

The first wireless power receiver 500b of FIG. 4C may further include the driving unit 570 in FIG. 9B.

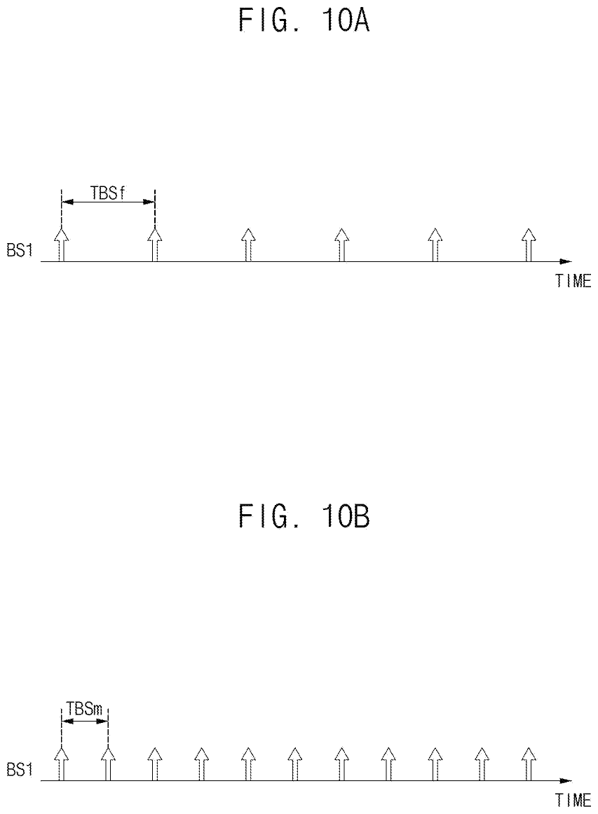

FIGS. 10A and 10B are diagrams for describing an operation of a wireless power transmission system according to example embodiments.

Referring to FIGS. 8A and 10A, when both the first wireless power transmitter 102 and the first wireless power receiver 502 are stationary devices, the first beacon signal BS1 may be periodically transmitted every first time interval TBSf, and thus, the synchronization operation described with reference to FIGS. 5A, 5B and 5C may be performed periodically every first cycle (or period).

Referring to FIGS. 8B, 8C, 8D and 10B, when at least one of the first wireless power transmitter 104 and the first wireless power receiver 504 is a mobile device, the first beacon signal BS1 may be periodically transmitted every second time interval TBSm, which is shorter than the first time interval TBSf, and thus, the synchronization operation described with reference to FIGS. 5A, 5B and 5C may be performed periodically every second cycle, which is shorter than the first cycle.

When at least one of the first wireless power transmitter 104 and the first wireless power receiver 504 is a mobile device, there may be a greater chance that a change in the operating environment will occur. Accordingly, the first beacon signal BS1 may be transmitted more frequently and the synchronization operation may be performed more frequently.

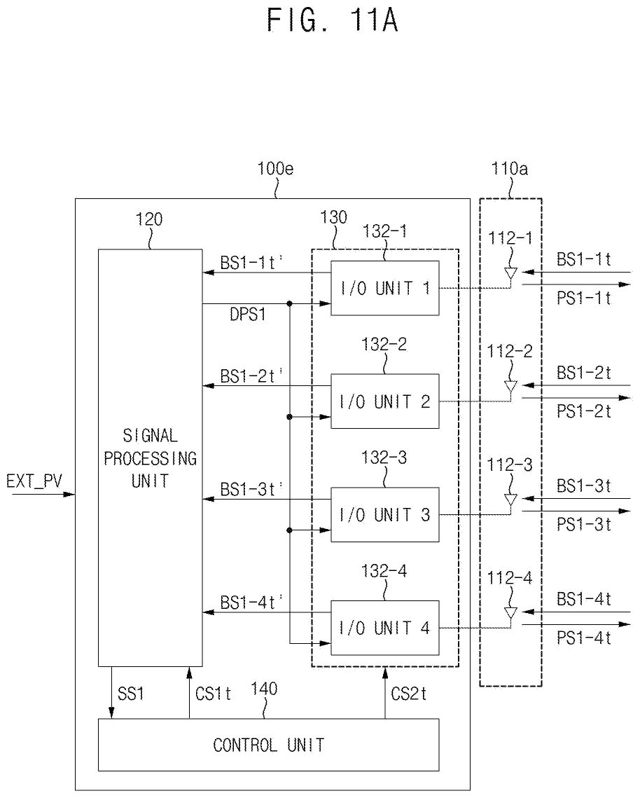

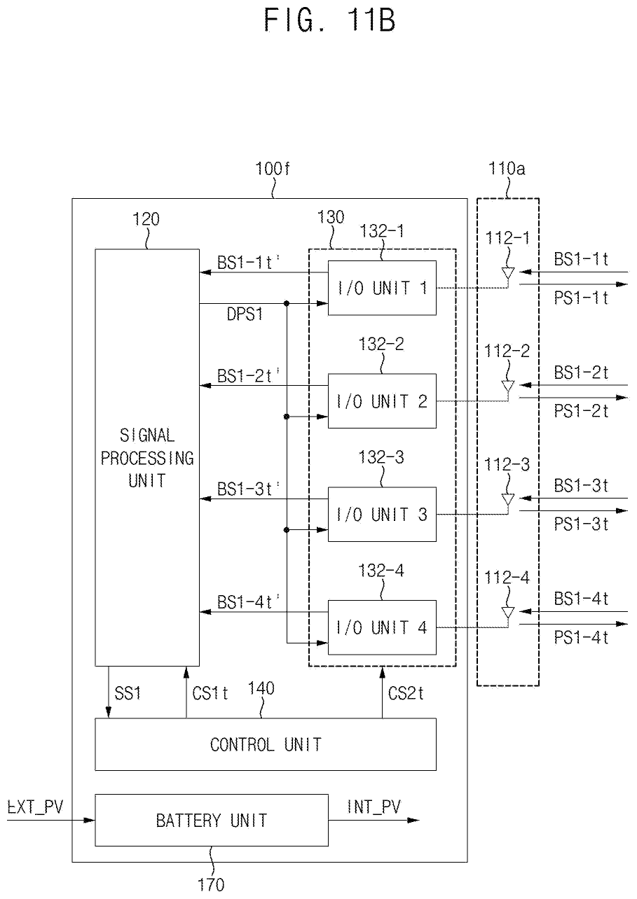

FIGS. 11A and 11B are block diagrams illustrating examples of a first wireless power transmitter included in a wireless power transmission system according to example embodiments. The descriptions repeated with FIG. 3A will be omitted.

Referring to FIG. 11A, a first wireless power transmitter 100e may include a first array antenna unit 110a, a signal processing unit 120, a transceiver unit 130 and a control unit 140.

The first wireless power transmitter 100e may be substantially the same as the first wireless power transmitter 100a of FIG. 3A, except that the first wireless power transmitter 100e further receives an external power voltage EXT_PV.

The first wireless power transmitter 100e may receive the external power voltage EXT_PV. The signal processing unit 120, the transceiver unit 130 and the control unit 140 may operate based on the external power voltage EXT_PV. In other words, the plurality of first power signals PS1-1t to PS1-4t may be generated based on the external power voltage EXT_PV.

Referring to FIG. 11B, a first wireless power transmitter 100f may include a first array antenna unit 110a, a signal processing unit 120, a transceiver unit 130, a control unit 140 and a battery unit 170.

The first wireless power transmitter 100f may be substantially the same as the first wireless power transmitter 100a of FIG. 3A, except that the first wireless power transmitter 100f further includes the battery unit 170.

The battery unit 170 may be charged based on the external power voltage EXT_PV, and may generate an internal power voltage INT_PV. For example, the battery unit 170 may include a multi-cell battery including a plurality of battery cells, a battery device including a plurality of battery packs, and/or the like. The signal processing unit 120, the transceiver unit 130 and the control unit 140 may operate based on the internal power voltage INT_PV. In other words, the plurality of first power signals PS1-1t to PS1-4t may be generated based on the internal power voltage INT_PV.

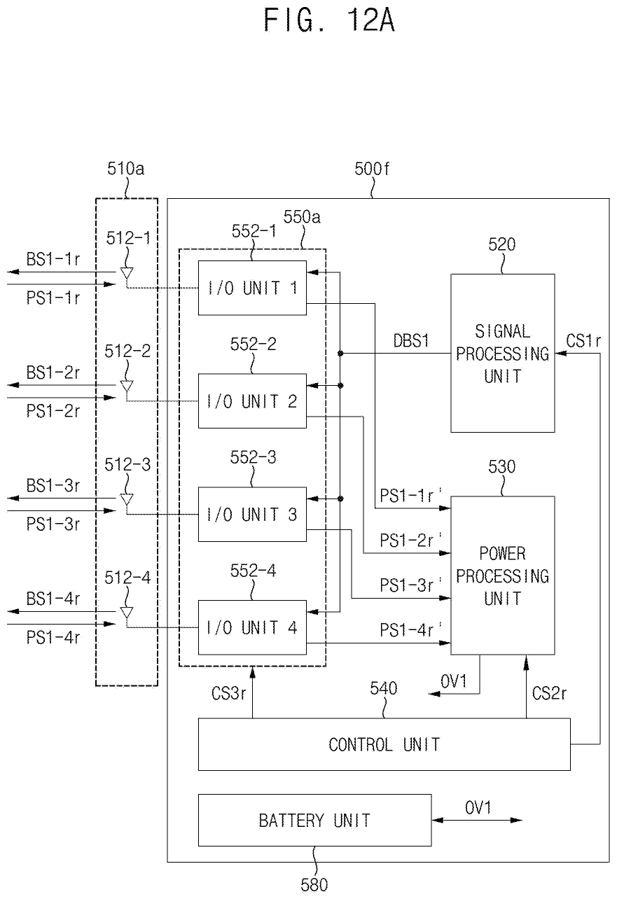

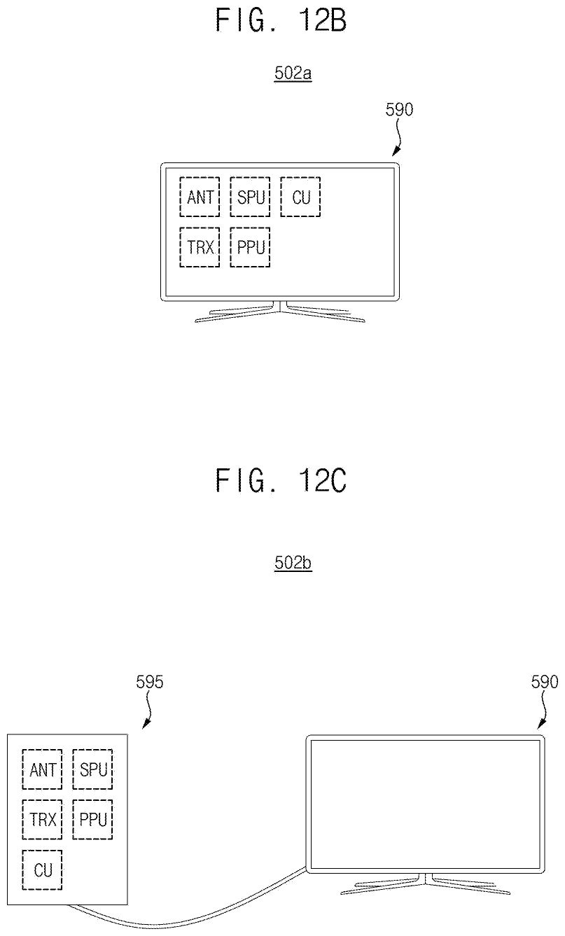

FIGS. 12A, 12B and 12C are block diagrams illustrating examples of a first wireless power receiver included in a wireless power transmission system according to example embodiments. The descriptions repeated with FIG. 4A will be omitted.

Referring to FIG. 12A, a first wireless power receiver 500f may include a first antenna unit 510a, a signal processing unit 520, a power processing unit 530, a control unit 540, a transceiver unit 550a and a battery unit 580.

The first wireless power receiver 500f may be substantially the same as the first wireless power receiver 500a of FIG. 4A, except that the first wireless power receiver 500f further includes the battery unit 580.

The battery unit 580 may be charged based on the first operating voltage OV1, and may provide the first operating voltage OV1. In other words, the first operating voltage OV1 may be supplied directly from the power processing unit 530, or may be supplied from the battery unit 580 after the battery unit 580 is charged based on the first operating voltage OV1. The battery unit 580 may be implemented similarly to the battery unit 170 in FIG. 11B.

The first wireless power receiver 500b of FIG. 4C may further include the battery unit 580 in FIG. 12A.

Referring to FIG. 12B, a first wireless power receiver 502a may include a main body unit 590 that performs its own functions. For example, when the first wireless power receiver 502a is a stationary device and a digital TV, the main body unit 590 may include various components to perform an image (or video) display function. An antenna unit ANT, a signal processing unit SPU, a power processing unit PPU, a control unit CU and a transceiver unit TRX may correspond to the first antenna unit 510a, the signal processing unit 520, the power processing unit 530, the control unit 540 and the transceiver unit 550a in FIG. 4A, respectively. The antenna unit ANT, the signal processing unit SPU, the power processing unit PPU, the control unit CU and the transceiver unit TRX may be included in the main body unit 590.

Referring to FIG. 12C, a first wireless power receiver 502b may include a main body unit 590 that performs its own functions, and may further include a module unit 595 that is electrically attachable to and detachable from the main body unit 590. At least a part or portion of the antenna unit ANT, the signal processing unit SPU, the power processing unit PPU, the control unit CU and the transceiver unit TRX may be included in the module unit 595.

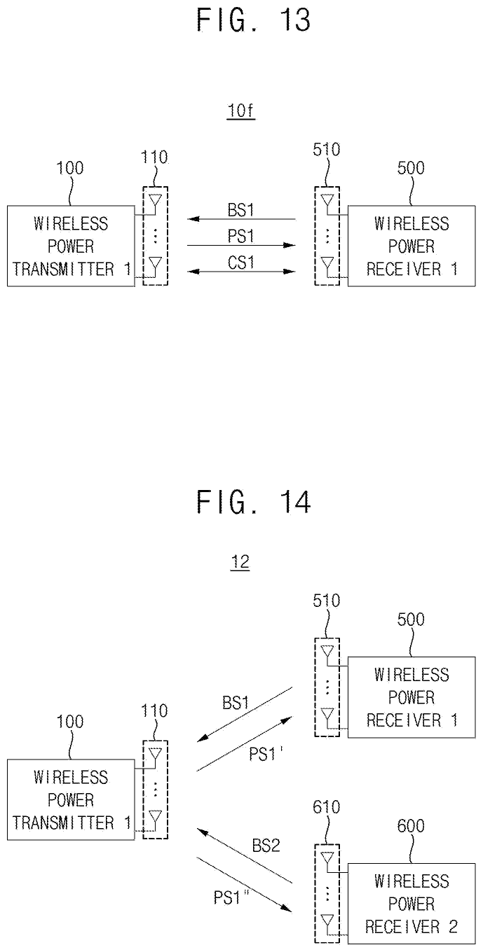

FIG. 13 is a block diagram illustrating a wireless power transmission system according to example embodiments. The descriptions repeated with FIG. 1 will be omitted.

Referring to FIG. 13, a wireless power transmission system 10f includes a first wireless power transmitter 100 and a first wireless power receiver 500.

The first wireless power transmitter 100 and the first wireless power receiver 500 may additionally exchange a first communication signal CS1 that includes information associated with power transmission (e.g., power transmission-related information). For example, the first communication signal CS1 may include information associated with power transmission efficiency, power/voltage level, etc. For example, the first communication signal CS1 may include information associated with the plurality of first power signals PS1, information associated with a status of the first wireless power transmitter 100 and/or a status of the first wireless power receiver 500, etc.

In some example embodiments, a channel for transmitting the first communication signal CS1 may be the same as a channel for transmitting the first beacon signal BS1 and the plurality of first power signals PS1. For example, the first communication signal CS1 may be generated by the signal processing units 120 and 520, and may be transmitted through the antennas 112-1 to 112-4 and 512-1 to 512-4. For example, the first beacon signal BS1 and the plurality of first power signals PS1 may be transmitted at (or with) a first frequency, and the first communication signal CS1 may be transmitted at (or with) a second frequency different from the first frequency.

In some example embodiments, the channel for transmitting the first communication signal CS1 may be different from the channel for transmitting the first beacon signal BS1 and the plurality of first power signals PS1. For example, the first communication signal CS1 may be generated by the signal processing units 120 and 520, and may be transmitted through other antennas implemented separately and independently from the antennas 112-1 to 112-4 and 512-1 to 512-4. For example, the first communication signal CS1 may be transmitted based on a communication protocol such as Bluetooth, Wi-Fi, or Zigbee.

In some example embodiments, the wireless power transmitter according to example embodiments may be implemented by combining two or more of the examples of FIGS. 3A, 6A, 7, 8A, 8B, 8C, 8D, 9A, 11A, 11B and 13. In some example embodiments, the wireless power receiver according to example embodiments may be implemented by combining two or more of the examples of FIGS. 4A, 4A, 6B, 7, 8A, 8B, 8C, 8D, 9B, 12A, 12B, 12C and 13.

FIG. 14 is a block diagram illustrating a wireless power transmission system according to example embodiments. The descriptions repeated with FIG. 1 will be omitted.

Referring to FIG. 14, a wireless power transmission system 12 includes a first wireless power transmitter 100, a first wireless power receiver 500 and a second wireless power receiver 600.

The wireless power transmission system 12 may be substantially the same as the wireless power transmission system 10 of FIG. 1, except that the wireless power transmission system 12 further includes the second wireless power receiver 600. FIG. 14 illustrates an example including one wireless power transmitter 100 and a plurality of wireless power receivers 500 and 600. However, more than two wireless power receivers may be employed in other example embodiments.

The first wireless power transmitter 100 may further receive a second beacon signal BS2 provided from the second wireless power receiver 600 through the first array antenna unit 110, and may further estimate a characteristic of a second wireless channel, which is a wireless channel between the first wireless power transmitter 100 and the second wireless power receiver 600, based on the second beacon signal BS2. The first wireless power transmitter 100 may generate a plurality of first power signals PS1′ and PS1″ whose phases and amplitudes are both adjusted based on the characteristic of the first wireless channel, the characteristic of the second wireless channel and the time reversal algorithm. The first wireless power transmitter 100 may output the plurality of first power signals PS1′ and PS1″ through the first array antenna unit 110.

The first wireless power receiver 500 may receive first parts (or portions) PS1′ of the plurality of first power signals PS1′ and PS1″, and may supply the first operating voltage OV1 based on the first parts PS1′ of the plurality of first power signals PS1′ and PS1″.

The second wireless power receiver 600 may include a second antenna unit 610 including at least one antenna. The second wireless power receiver 600 may output the second beacon signal BS2 through the second antenna unit 610, may receive second parts PS1″ of the plurality of first power signals PS1′ and PS1″ through the second antenna unit 610, and may supply a second operating voltage OV2 based on the second parts PS1″ of the plurality of first power signals PS1′ and PS1″. The second wireless power receiver 600 and the second antenna unit 610 may be similar to the first wireless power receiver 500 and the first antenna unit 510, respectively. For example, the second wireless power receiver 600 may be implemented as described with reference to FIGS. 4A, 4C, 6B, 7, 8A, 8B, 8C, 8D, 9B, 12A, 12B, 12C and 13.

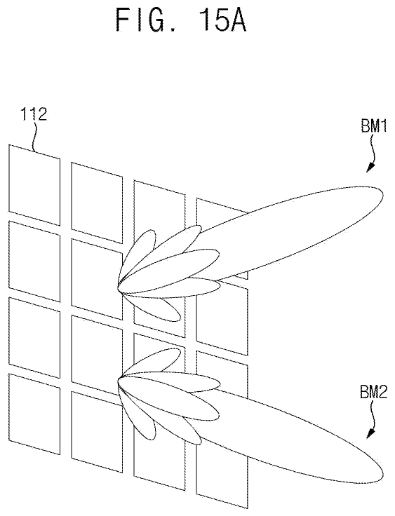

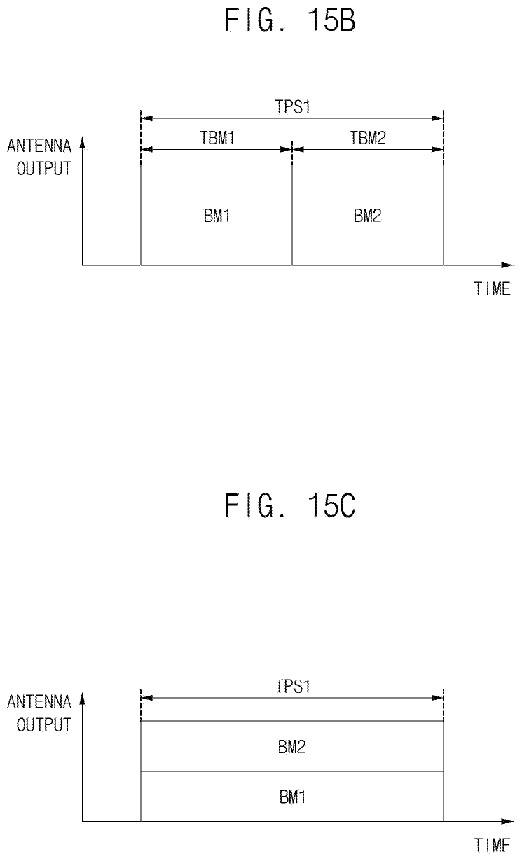

FIGS. 15A, 15B and 15C are diagrams for describing a first array antenna unit of a first wireless power transmitter included in a wireless power transmission system according to example embodiments. The descriptions repeated with FIGS. 2A, 2B and 2C will be omitted.

Referring to FIGS. 14 and 15A, first beams BM1 and second beams BM2 may be output from the plurality of antennas 112 included in the first array antenna unit 110. For example, the first beams BM1 may correspond to the first parts PS1′ provided to the first wireless power receiver 500 among the plurality of first power signals PS1′ and PS1″ generated by the first wireless power transmitter 100. The second beams BM2 may correspond to the second parts PS1″ provided to the second wireless power receiver 600 among the plurality of first power signals PS1′ and PS1″ generated by the first wireless power transmitter 100. Two or more beam groups may be formed using the array antenna.

Referring to FIG. 15B, the first beams BM1 and the second beams BM2 may be formed and transmitted during different time intervals. For example, during the entire time interval TPS1 during which the plurality of first power signals PS1′ and PS1″ are transmitted, the first beams BM1 may be formed and provided to the first wireless power receiver 500 during a first time interval TBM1, and the second beams BM2 may be formed and provided to the second wireless power receiver 600 during a second time interval TBM2 subsequent to the first time interval TBM1. In other words, the first and second beams BM1 and BM2 may be sequentially transmitted.

Referring to FIG. 15C, the first beams BM1 and the second beams BM2 may be formed and transmitted substantially simultaneously or concurrently. For example, during the entire time interval TPS1 during which the plurality of first power signals PS1′ and PS1″ are transmitted, the first beams BM1 and the second beams BM2 may be formed substantially simultaneously and provided to the first wireless power receiver 500 and the second wireless power receiver 600 substantially simultaneously. In other words, the first and second beams BM1 and BM2 may be transmitted at the same time.

The amount of power provided to the first wireless power receiver 500 by the first beams BM1 during the entire time interval TPS1 in the example of FIG. 15B and the amount of power provided to the first wireless power receiver 500 by the first beams BM1 during the entire time interval TPS1 in the example of FIG. 15C may be substantially the same as each other. Similarly, the amount of power provided to the second wireless power receiver 600 by the second beams BM2 during the entire time interval TPS1 in the example of FIG. 15B and the amount of power provided to the second wireless power receiver 600 by the second beams BM2 during the entire time interval TPS1 in the example of FIG. 15C may be substantially the same as each other.

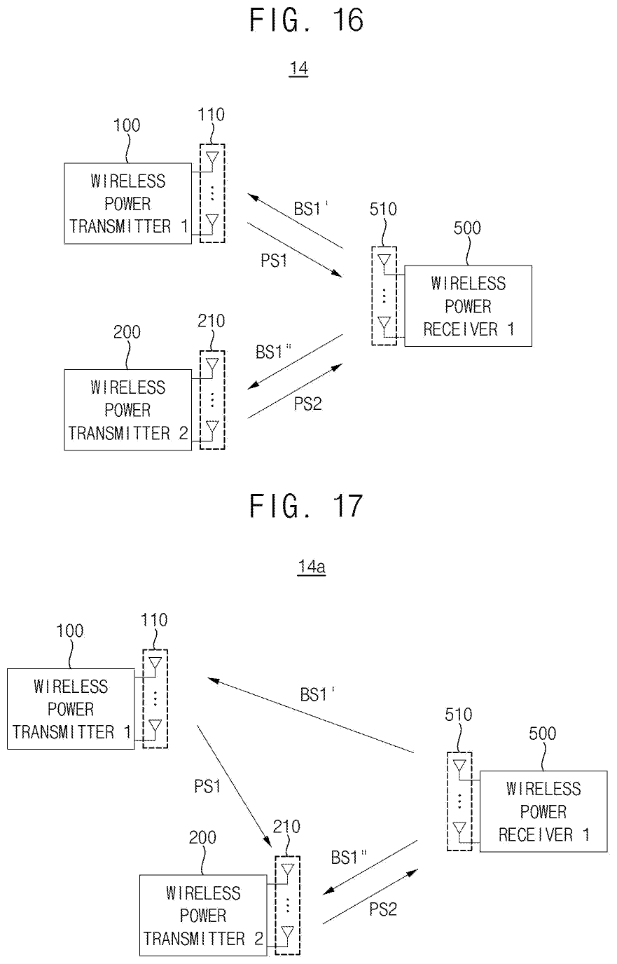

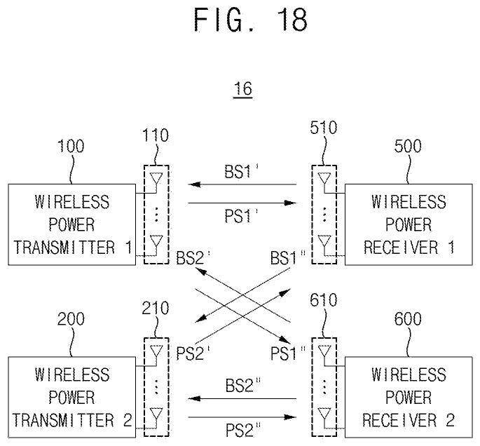

FIGS. 16 and 17 are block diagrams illustrating a wireless power transmission system according to example embodiments. The descriptions repeated with FIG. 1 will be omitted.

Referring to FIG. 16, a wireless power transmission system 14 includes a first wireless power transmitter 100, a second wireless power transmitter 200 and a first wireless power receiver 500.

The wireless power transmission system 14 may be substantially the same as the wireless power transmission system 10 of FIG. 1, except that the wireless power transmission system 14 further includes the second wireless power transmitter 200. FIG. 16 illustrates an example including a plurality of wireless power transmitters 100 and 200 and one wireless power receiver 500. However, more than two wireless power transmitters may be employed in other example embodiments.

The first wireless power transmitter 100 may receive first parts BS1′ of the first beacon signals BS1′ and BS1″ provided from the first wireless power receiver 500 through the first array antenna unit 110, and may estimate the characteristic of the first wireless channel based on the first parts BS1′ of the first beacon signals BS1′ and BS1″. The first wireless power transmitter 100 may generate and output the plurality of first power signals PS1 whose phases and amplitudes are both adjusted based on the characteristic of the first wireless channel and the time reversal algorithm.

The second wireless power transmitter 200 may include a second array antenna unit 210 including a plurality of antennas that are arranged in a 2D matrix. The second wireless power transmitter 200 may receive second parts BS1″ of the first beacon signals BS1′ and BS1″ through the second array antenna unit 210, and may estimate a characteristic of a third wireless channel, which is a wireless channel between the second wireless power transmitter 200 and the first wireless power receiver 500, based on the second parts BS1″ of the first beacon signals BS1′ and BS1″. The second wireless power transmitter 200 may generate a plurality of second power signals PS2 whose phases and amplitudes are both adjusted based on the characteristic of the third wireless channel and the time reversal algorithm. The second wireless power transmitter 200 may output the plurality of second power signals PS2 through the second array antenna unit 210. The second wireless power transmitter 200 and the second array antenna unit 210 may be similar to the first wireless power transmitter 100 and the first array antenna unit 110, respectively. For example, the second wireless power transmitter 200 may be implemented as described with reference to FIGS. 3A, 6A, 7, 8A, 8B, 8C, 8D, 9A, 11A, 11B and 13.

The first wireless power receiver 500 may further receive the plurality of second power signals PS2 through the first antenna unit 510, and may supply the first operating voltage OV1 based on the plurality of first power signals PS1 and the plurality of second power signals PS2.

Referring to FIG. 17, a wireless power transmission system 14a includes a first wireless power transmitter 100, a second wireless power transmitter 200 and a first wireless power receiver 500. The descriptions repeated with FIG. 16 will be omitted.

The second wireless power transmitter 200 may further receive the plurality of first power signals PS1 through the second array antenna unit 210. The second wireless power transmitter 200 may generate the plurality of second power signals PS2 based on the plurality of first power signals PS1, the characteristic of the third wireless channel and the time reversal algorithm.

The first wireless power receiver 500 may receive the plurality of second power signals PS2 rather than the plurality of first power signals PS1 through the first antenna unit 510. The first wireless power receiver 500 may supply the first operating voltage OV1 based on the plurality of second power signals PS2 that are generated based on the plurality of first power signals PS1.

The second wireless power transmitter 200 may operate as a power relay device or a power transmission repeater. For example, if the distance between the first wireless power transmitter 100 and the first wireless power receiver 500 exceeds a reference distance, and the direct power transmission efficiency from the first wireless power transmitter 100 to the first wireless power receiver 500 is consistently lower than the reference power transmission efficiency, another approach can be employed. For example, rather than directly transmitting the plurality of first power signals PS1 to the first wireless power receiver 500, the plurality of second power signals PS2 may be generated based on the plurality of first power signals PS1 using the second wireless power transmitter 200 and may be transmitted to the first wireless power receiver 500. For example, the second wireless power transmitter 200 may operate as a power receiver in relation to the first wireless power transmitter 100, and may operate as a power transmitter in relation to the first wireless power receiver 500. A synchronization operation between the first wireless power transmitter 100 and the second wireless power transmitter 200 may be additionally performed.

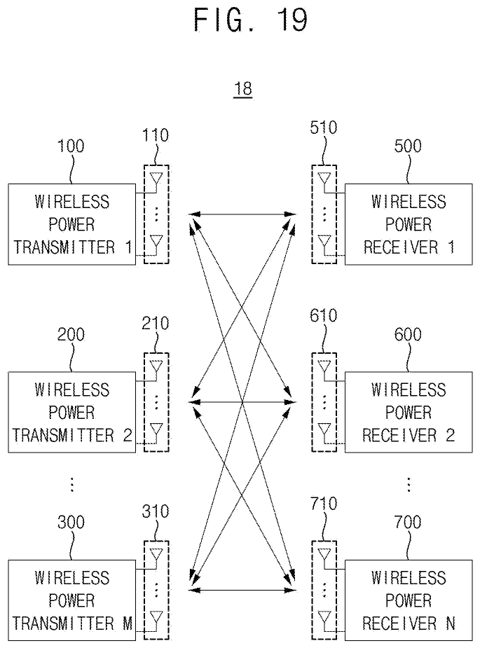

FIGS. 18 and 19 are block diagrams illustrating a wireless power transmission system according to example embodiments. The descriptions repeated with FIG. 1 will be omitted.

Referring to FIG. 18, a wireless power transmission system 16 includes a first wireless power transmitter 100, a second wireless power transmitter 200, a first wireless power receiver 500 and a second wireless power receiver 600.

The wireless power transmission system 16 may be substantially the same as the wireless power transmission system 10 of FIG. 1, except that the wireless power transmission system 16 further includes the second wireless power transmitter 200 and the second wireless power receiver 600. FIG. 18 illustrates an example including a plurality of wireless power transmitters 100 and 200 and a plurality of wireless power receivers 500 and 600.

The first wireless power receiver 500 may output the first beacon signals BS1′ and BS1″, and the second wireless power receiver 600 may output second beacon signals BS2′ and BS2″.

The first wireless power transmitter 100 may receive the first parts BS1′ of the first beacon signals BS1′ and BS1″, and may estimate the characteristic of the first wireless channel based on the first parts BS1′ of the first beacon signals BS1′ and BS1″. The first wireless power transmitter 100 may receive first parts BS2′ of the second beacon signals BS2′ and BS2″, and may estimate the characteristic of the second wireless channel based on the first parts BS2′ of the second beacon signals BS2′ and BS2″. The first wireless power transmitter 100 may generate and output the plurality of first power signals PS1′ and PS1″ whose phases and amplitudes are both adjusted based on the characteristic of the first wireless channel, the characteristic of the second wireless channel and the time reversal algorithm.

The second wireless power transmitter 200 may receive the second parts BS1″ of the first beacon signals BS1′ and BS1″, and may estimates the characteristic of the third wireless channel based on the second parts BS1″ of the first beacon signals BS1′ and BS1″. The second wireless power transmitter 200 may receive second parts BS2″ of the second beacon signals BS2′ and BS2″, and may estimate a characteristic of a fourth wireless channel, which is a wireless channel between the second wireless power transmitter 200 and the second wireless power receiver 600, based on the second parts BS2″ of the second beacon signals BS2′ and BS2″. The second wireless power transmitter 200 may generate and output the plurality of second power signals PS2′ and PS2″ whose phases and amplitudes are both adjusted based on the characteristic of the third wireless channel, the characteristic of the fourth wireless channel and the time reversal algorithm.

The first wireless power receiver 500 may receive the first parts PS1′ of the plurality of first power signals PS1′ and PS1″ and the first parts PS2′ of the plurality of second power signals PS2′ and PS2″. The first wireless power receiver 500 may supply the first operating voltage OV1 based on the first parts PS1′ of the plurality of first power signals PS1′ and PS1″ and the first parts PS2′ of the plurality of second power signals PS2′ and PS2″. The second wireless power receiver 600 may receive the second parts PS1″ of the plurality of first power signals PS1′ and PS1″ and second parts PS2″ of the plurality of second power signals PS2′ and PS2″. The second wireless power receiver 600 may supply the second operating voltage OV2 based on the second parts PS1″ of the plurality of first power signals PS1′ and PS1″ and the second parts PS2″ of the plurality of second power signals PS2′ and PS2″.

Referring to FIG. 19, a wireless power transmission system 18 includes first to M-th wireless power transmitters 100, 200 and 300, and first to N-th wireless power receivers 500, 600 and 700, where each of M and N is a natural number or positive integer greater than or equal to two.

As with the example of FIG. 18, FIG. 19 illustrates an example including a plurality of wireless power transmitters 100, 200 and 300 and a plurality of wireless power receivers 500, 600 and 700. The M-th wireless power transmitter 300 and a M-th array antenna unit 310 included therein may be similar to the first wireless power transmitter 100 and the first array antenna unit 110, respectively. The N-th wireless power receiver 700 and a N-th antenna unit 710 included therein may be similar to the first wireless power receiver 500 and the first antenna unit 510, respectively.

An operation between one of the wireless power transmitters 100, 200 and 300 and one of the wireless power receivers 500, 600 and 700 may be implemented as described with reference to FIGS. 1 through 18. For example, M and N may be equal to or different from each other, according to example embodiments.

As described with reference to FIGS. 1, 14, 16, 18 and 19, the wireless power transmission system according to example embodiments may be implemented in four scenarios, based on combinations of the quantity of wireless power transmitters (e.g., one or multiple) and the quantity of wireless power receivers (e.g., one or multiple).

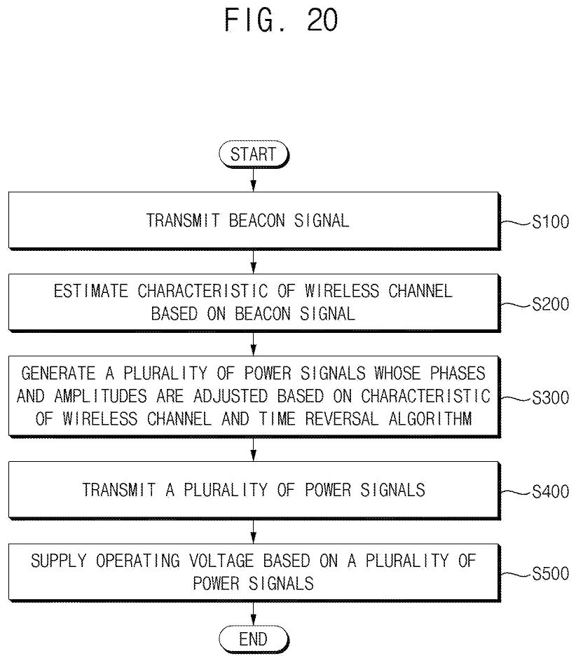

FIG. 20 is a flowchart illustrating a method of operating a wireless power transmission system according to example embodiments.

Referring to FIGS. 1 and 20, in a method of operating a wireless power transmission system according to example embodiments, a wireless power receiver transmits a beacon signal to the wireless power transmitter (operation S100). For example, when the wireless power transmission system 10 includes the first wireless power transmitter 100 and the first wireless power receiver 500, the first wireless power receiver 500 may transmit the first beacon signal BS1 to the first wireless power transmitter 100 through the first antenna unit 510.

The wireless power transmitter estimates a characteristic of a wireless channel based on the beacon signal (operation S200). For example, the first wireless power transmitter 100 may estimate the characteristic of the first wireless channel that is located between the first wireless power transmitter 100 and the first wireless power receiver 500, based on the first beacon signal BS1 received through the first array antenna unit 110.

The wireless power transmitter generates a plurality of power signals whose phases and amplitudes are both adjusted based on the characteristic of the wireless channel and a time reversal algorithm (operation S300). For example, the first wireless power transmitter 100 may generate the plurality of first power signals PS1 whose phases and amplitudes are both adjusted based on the characteristic of the first wireless channel and the time reversal algorithm.

The wireless power transmitter transmits the plurality of power signals to the wireless power receiver (operation S400). For example, the first wireless power transmitter 100 may transmit the plurality of first power signals PS1 to the first wireless power receiver 500 through the first array antenna unit 110.

The wireless power receiver supplies an operating voltage based on the plurality of power signals (operation S500). For example, the first wireless power receiver 500 may supply the first operating voltage OV1 based on the plurality of first power signals PS1 received through the first antenna unit 510.

In some example embodiments, when the wireless power transmission system includes a plurality of wireless power transmitters and/or a plurality of wireless power receivers as described with reference to FIGS. 14, 16, 18 and 19, operations S100, S200, S300, S400 and S500 may be performed between one wireless power transmitter and one wireless power receiver.

In some example embodiments, in the wireless power transmission system, the plurality of first power signals may be adjusted, controlled, and/or modulated differently, based on at least one of the quantity of the wireless power transmitters, the quantity of the wireless power receivers, a movability of each wireless power transmitter, and a movability of each wireless power receiver.

As will be appreciated by those skilled in the art, example embodiments may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain or store a program for use by or in connection with an instruction execution system, apparatus, or device. For example, the computer readable medium may be a non-transitory computer readable medium.

The example embodiments described herein may be applied to various electronic devices and systems that perform the wireless power transmission. For example, the example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automobile, etc.

The foregoing is illustrative of example embodiments of the present disclosure and is not to be construed as limiting thereof. Although some example embodiments have been described, those skilled in the art will readily appreciate that many modifications are possible in the example embodiments without materially departing from the novel teachings of the present disclosure. Accordingly, all such modifications are intended to be included within the scope of the present disclosure as set forth by the claims.

What is claimed is:

1. A wireless power transmission system comprising:
a first wireless power transmitter including a first array antenna unit including a plurality of antennas, the first wireless power transmitter configured to receive a first beacon signal through the first array antenna unit, to estimate a characteristic of a first wireless channel based on the first beacon signal, to generate a plurality of first power signals, and to output the plurality of first power signals through the first array antenna unit, wherein phases and amplitudes of the plurality of first power signals are adjusted based on the characteristic of the first wireless channel and a time reversal algorithm; and
a first wireless power receiver including a first antenna unit including at least one antenna, the first wireless power receiver configured to output the first beacon signal through the first antenna unit, to receive the plurality of first power signals through the first antenna unit, and to generate a first operating voltage based on the plurality of first power signals,
wherein the first wireless channel is between the first wireless power transmitter and the first wireless power receiver, and
wherein the plurality of first power signals are adjusted differently based on a quantity of wireless power transmitters including the first wireless power transmitter, a quantity of wireless power receivers including the first wireless power receiver, a movement of the first wireless power transmitter, or a movement of the first wireless power receiver.

2. The wireless power transmission system of claim 1, wherein, when a first power transmission efficiency between the first wireless power transmitter and the first wireless power receiver is lower than a reference power transmission efficiency, the phases and the amplitudes of the plurality of first power signals are adjusted, or at least one of the first array antenna unit and the first antenna unit is moved.

3. The wireless power transmission system of claim 2, wherein, when the first power transmission efficiency is lower than the reference power transmission efficiency, at least one of the first wireless power transmitter and the first wireless power receiver generates an alarm.

4. The wireless power transmission system of claim 1, wherein at least one of the first wireless power transmitter and the first wireless power receiver is a stationary device with a fixed position.

5. The wireless power transmission system of claim 1, wherein at least one of the first wireless power transmitter and the first wireless power receiver is a mobile device.

6. The wireless power transmission system of claim 1, further comprising:
a second wireless power receiver including a second antenna unit including at least one antenna, the second wireless power receiver configured to output a second beacon signal through the second antenna unit, to receive the plurality of first power signals through the second antenna unit, and to generate a second operating voltage based on the plurality of first power signals.

7. The wireless power transmission system of claim 6,
wherein the first wireless power transmitter is further configured to receive the second beacon signal through the first array antenna unit, to estimate a characteristic of a second wireless channel based on the second beacon signal, and to generate the plurality of first power signals based on the characteristic of the first wireless channel, the characteristic of the second wireless channel and the time reversal algorithm,
wherein the second wireless channel is between the first wireless power transmitter and the second wireless power receiver,
wherein a first part of the plurality of first power signals forms a first beam to be provided to the first wireless power receiver, and
wherein a second part of the plurality of first power signals forms a second beam to be provided to the second wireless power receiver.

8. The wireless power transmission system of claim 1, further comprising:
a second wireless power transmitter including a second array antenna unit including a plurality of antennas, the second wireless power transmitter configured to receive the first beacon signal through the second array antenna unit, to estimate a characteristic of a second wireless channel based on the first beacon signal, to generate a plurality of second power signals, and to output the plurality of second power signals through the second array antenna unit, wherein phases and amplitudes of the plurality of second power signals are adjusted based on the characteristic of the second wireless channel and the time reversal algorithm, and
wherein the second wireless channel is between the second wireless power transmitter and the first wireless power receiver.

9. The wireless power transmission system of claim 8, wherein the first wireless power receiver is further configured to receive the plurality of second power signals through the first antenna unit, and to generate the first operating voltage based on the plurality of first power signals and the plurality of second power signals.

10. The wireless power transmission system of claim 8,
wherein the second wireless power transmitter is further configured to receive the plurality of first power signals through the second array antenna unit, and to generate the plurality of second power signals based on the plurality of first power signals, the characteristic of the second wireless channel and the time reversal algorithm, and
wherein the first wireless power receiver is further configured to receive the plurality of second power signals through the first antenna unit, and to generate the first operating voltage based on the plurality of second power signals that are generated based on the plurality of first power signals.

11. The wireless power transmission system of claim 1, wherein the first wireless power transmitter includes:
a signal processing circuit configured to generate a first default power signal, and to detect a phase and an amplitude of the first beacon signal;
a transceiver circuit configured to provide the first beacon signal to the signal processing circuit, and to generate the plurality of first power signals by modulating the first default power signal such that a phase of the first default power signal is time-reversed and an amplitude of the first default power signal is amplified; and
a control circuit configured to control operations of the signal processing circuit and the transceiver circuit.

12. The wireless power transmission system of claim 11,
wherein the signal processing circuit, the transceiver circuit and the control circuit are configured to operate based on an external power voltage, and
wherein the plurality of first power signals are generated based on the external power voltage.

13. The wireless power transmission system of claim 11, wherein the first wireless power transmitter further includes:
a battery unit configured to be charged based on an external power voltage, and to generate an internal power voltage,
wherein the signal processing circuit, the transceiver circuit and the control circuit are configured to operate based on the internal power voltage, and
wherein the plurality of first power signals are generated based on the internal power voltage.

14. The wireless power transmission system of claim 1, wherein the first wireless power receiver includes:
a signal processing circuit configured to generate the first beacon signal;
a power processing circuit configured to generate the first operating voltage based on the plurality of first power signals; and
a control circuit configured to control operations of the signal processing circuit and the power processing circuit.

15. The wireless power transmission system of claim 14, wherein the first wireless power receiver further includes:
a main body configured to perform functions of the first wireless power receiver, and
wherein the first antenna circuit, the signal processing circuit, the power processing circuit and the control circuit are included in the main body.

16. The wireless power transmission system of claim 14, wherein the first wireless power receiver further includes:
a main body configured to perform functions of the first wireless power receiver; and
a module configured to be electrically attachable to and detachable from the main body, and
wherein the first antenna circuit, the signal processing circuit, the power processing circuit and the control circuit are included in the module.

17. The wireless power transmission system of claim 1, wherein the first wireless power transmitter and the first wireless power receiver are further configured to exchange a first communication signal including information associated with power transmission.

18. The wireless power transmission system of claim 1, wherein the first antenna unit included in the first wireless power receiver includes a plurality of antennas arranged.

19. A method of operating a wireless power transmission system including a first wireless power transmitter and a first wireless power receiver, the method comprising:
transmitting, by the first wireless power receiver including a first antenna unit, a first beacon signal to the first wireless power transmitter through the first antenna unit, the first antenna unit including at least one antenna;
estimating, by the first wireless power transmitter including a first array antenna unit, a characteristic of a first wireless channel based on the first beacon signal received through the first array antenna unit, the first array antenna unit including a plurality of antennas, the first wireless channel being between the first wireless power transmitter and the first wireless power receiver;
generating, by the first wireless power transmitter, a plurality of first power signals whose phases and amplitudes are adjusted based on the characteristic of the first wireless channel and a time reversal algorithm;
transmitting, by the first wireless power transmitter, the plurality of first power signals to the first wireless power receiver through the first array antenna unit; and
generating, by the first wireless power receiver, a first operating voltage based on the plurality of first power signals received through the first antenna unit, and
wherein the plurality of first power signals are adjusted differently based on a quantity of wireless power transmitters including the first wireless power transmitter, a quantity of wireless power receivers including the first wireless power receiver, a motion of the first wireless power transmitter, or a motion of the first wireless power receiver.

20. A wireless power transmission system comprising:
a first wireless power transmitter to a M-th wireless power transmitter configured to generate a plurality of first power signals to a plurality of M-th power signals, where M is a natural number greater than or equal to two; and
a first wireless power receiver to a N-th wireless power receiver configured to generate a first beacon signal to a N-th beacon signal, and to operate based on the plurality of first power signals to the M-th power signals, where N is a natural number greater than or equal to two,
wherein a X-th wireless power transmitter among the first to M-th wireless power transmitters includes a X-th array antenna unit including a plurality of antennas arranged in a two-dimensional matrix, where X is a natural number greater than or equal to one and less than or equal to M,
wherein a Y-th wireless power receiver among the first to N-th wireless power receivers includes a Y-th antenna unit including at least one antenna, where Y is a natural number greater than or equal to one and less than or equal to N,
wherein the X-th wireless power transmitter is configured to receive the first to N-th beacon signals through the X-th array antenna unit, to estimate characteristics of a first wireless channel to a N-th wireless channel based on the first to N-th beacon signals, to generate a plurality of X-th power signals whose phases and amplitudes are adjusted based on the characteristics of the first to N-th wireless channels and a time reversal algorithm, and to output the plurality of X-th power signals through the X-th array antenna unit,
wherein the first to N-th wireless channels are between the X-th wireless power transmitter and the first to N-th wireless power receivers,
wherein the Y-th wireless power receiver is configured to output the Y-th beacon signal through the Y-th antenna unit, to receive the plurality of first to M-th power signals through the Y-th antenna unit, and to generate a Y-th operating voltage based on the plurality of first to M-th power signals,
wherein, when a power transmission efficiency between the X-th wireless power transmitter and the Y-th wireless power receiver is lower than a reference power transmission efficiency, the phases and the amplitudes of the plurality of X-th power signals are adjusted, or at least one of the X-th array antenna unit and the Y-th antenna unit is moved, or at least one of the X-th wireless power transmitter and the Y-th wireless power receiver generates an alarm signal,
wherein each of the first to M-th wireless power transmitters and the first to N-th wireless power receivers is a stationary device with a fixed position, or a mobile device whose position is changeable, and
wherein the plurality of first to M-th power signals are adjusted differently based on at least one of a quantity of the first to M-th wireless power transmitters, a quantity of the first to N-th wireless power receivers, a movement of each of the first to M-th wireless power transmitters, and a movement of each of the first to N-th wireless power receivers.
